(19) United States
(12) Patent Application Publication
(10) Pub. No.: US 2008/0227011 A1
(43) Pub. Date: Sep. 18, 2008

(54) TONER, DEVELOPER, AND IMAGE FORMING APPARATUS

(76) Inventors: Shinichi KURAMOTO, Numazu-shi (JP); Shinji Ohtani, Sunto-gun (JP); Yoshihiro Norikane, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/047,437

(22) Filed: Mar. 13, 2008

(30) Foreign Application Priority Data
Mar. 15, 2007 (JP) 2007-066176
Dec. 14, 2007 (JP) 2007-323042

(51) Int. Cl. G03G 9/097; G03G 15/06

(52) U.S. Cl. 430/108.3; 399/222

(57) ABSTRACT

A toner including a binder resin, a colorant, and a silicon-containing polymer, which is manufactured by a method including: discharging a toner constituent liquid including toner constituents including the binder resin, the colorant, and the silicon-containing polymer, from at least one discharge opening to form liquid droplets thereof; and converting the liquid droplets into solid toner particles in a granulation space.

### BACKGROUND OF THE INVENTION

1. Field of the Invention

The present invention relates to a toner for use in electrophotography. In addition, the present invention also relates to a developer and an image forming apparatus using the toner.

2. Discussion of the Background

A typical electrophotographic method includes: an electrostatic latent image forming process in which an electrostatic latent image is formed on a photoreceptor (hereinafter referred to as an electrostatic latent image bearing member, an image bearing member, or an electrophotographic photoreceptor, unless otherwise described) including a photoconductive material; a developing process in which the electrostatic latent image is developed with a toner to form a toner image; a transfer process in which the toner image is transferred onto a recording medium such as paper; a fixing process in which the toner image is fixed on the recording medium by application of heat, pressure, and/or solvent vapor; and a cleaning process in which residual toner particles remaining on the photoreceptor are removed therefrom.

In electrophotography, electrostatic recording, electrostatic printing, etc., a developer develops an electrostatic latent image formed on an electrostatic latent image bearing member in the developing process. Subsequently, the developer is transferred from the electrostatic latent image bearing member onto a transfer member such as a transfer paper in the transfer process, and finally fixed on the transfer paper in the fixing process. The developer is broadly classified into a two-component developer including a carrier and a toner, and a one-component developer including no carrier and a toner. The toner may be either a magnetic toner or a non-magnetic toner.

The toner for use in electrophotography is required to be manufactured by an energy-saving and environmentally-friendly method.

Conventionally, a pulverization toner, which is manufactured by a pulverization method in which toner components including a binder resin (such as a styrene resin and a polyester resin) and internal additives (such as a colorant) are melt-kneaded and the melt-kneaded mixture is pulverized, is widely used for electrophotography, electrostatic recording, electrostatic printing, etc.

In order to produce toner particles having a uniform shape by the pulverization method, the toner components have to be evenly mixed before pulverized. Since pulverized sections have random shape, the resultant toner particles typically have an irregular shape. It is difficult to control the shape and structure of the resultant toner by the pulverization method. Particularly, when the toner components include a large amount of internal additives, such as a colorant, a release agent, and/or a charge controlling agent, the melt-kneaded mixture tends to be pulverized at interfaces between the internal additives and the binder resin. As a result, the internal additives tend to expose at the surfaces of the resultant toner particles. Such a toner particle has variation in chargeability by location, resulting in deterioration of fluidity and chargeability of the resultant toner.

Toners are required to have a much smaller particle diameter to respond to a recent demand for high image quality. However, as the particle diameter of a toner decreases, the following problems may arise.
(1) The pulverization energy exponentially increases.
(2) A combination of a small particle diameter and an irregular shape deteriorates fluidity of the toner, resulting in deterioration of toner feedability, transferability, and cleanability.
(3) Chargeability largely varies by location in each toner particle because internal additives may expose at the surface of the toner particle.

On the other hand, chemical toner manufacturing methods such as a suspension polymerization method, an emulsion aggregation method, a dissolution suspension method, a polyester elongation method, and a phase-inversion emulsification method, have been proposed.

A reference entitled “Encapsulated Polymerization Toner (Takuji KISHIMOTO, Journal of the Imaging Society of Japan, Vol. 43 (2004), No. 1, 33-39)” discloses a suspension polymerization method. The suspension polymerization method includes, for example, the following steps: dispersing internal additives such as a colorant, a release agent, and a charge controlling agent, and a polymerization initiator in a monomer, to prepare a toner component dispersion; dispersing the toner component dispersion in an aqueous medium containing a dispersing agent, to prepare a suspension including liquid droplets of the toner component dispersion; and heating the suspension to polymerize the monomer in the liquid droplets, to form toner particles.

Japanese Patent No. (hereinafter referred to as JP) 3141783 and a reference entitled “Konica-Minolta Digital Toner by Emulsion Coagulation Method (Mikio KOUYAMA, Journal of the Imaging Society of Japan, Vol. 43 (2004), No. 1, 40-47)” have disclosed an emulsion aggregation method. The emulsion aggregation method includes, for example, the following steps: dispersing a colorant in an aqueous medium containing a surfactant to prepare a colorant dispersion; adding a polymerization initiator, a styrene monomer, and an acrylic monomer in another aqueous medium containing a surfactant so that the monomers are emulsion-polymerized, to prepare a resin emulsion; mixing the colorant dispersion and the resin emulsion, optionally together with other dispersions each including internal additives such as a release agent and a charge controlling agent, respectively; adding a pH controlling agent and/or an aggregating agent to the mixture so that the dispersoids are aggregated to have a desired particle diameter; and heating and agitating the mixture so that the aggregated dispersoids are fused with each other to form toner particles.

Published unexamined Japanese patent application No. (hereinafter referred to as JP-A) 07-152202 and a reference entitled “Technology Development of Spherical Polyester Toner by Suspension of Polymer/Pigment Solution and Solvent Removal Method (Yutaka SUGIZAKI et al., Journal of the Imaging Society of Japan, Vol. 43 (2004), No. 1, 48-53)” have disclosed a dissolution suspension method. The dissolution suspension method includes, for example, the following steps: dispersing or dissolving a binder resin and internal additives such as a colorant, a release agent, and a charge controlling agent in a low-boiling volatile organic solvent, to prepare an oily component liquid; dispersing the oily component liquid in an aqueous medium containing a dispersing agent, to prepare a suspension of liquid droplets of the oily component liquid; and removing the organic solvent from the suspension, to form toner particles along with volume contraction. Unlike the suspension polymerization method and the emulsion aggregation method, the dissolution suspension method is capable of using various kinds of resins. It is particularly advantageous that polyester resins, which are useful for a full-color toner capable of providing images with good transparency and smoothness, can be used therefor.

A reference entitled “Development of New Polymerization Toner (Fumihiro SASAKI et al., Journal of the Imaging Society of Japan, Vol. 43 (2004), No. 1, 54-59)” discloses a polyester elongation method. The polyester elongation method includes, for example, the following steps: dissolving or dispersing a binder resin including a reactive polyester resin and internal additives such as a colorant, a release agent, and a charge controlling agent in an organic solvent, to prepare an oily component liquid; dispersing the oily component liquid in an aqueous medium to prepare a dispersion of the oily component liquid; and removing the organic solvent from the dispersion while subjecting the reactive polyester resin to an elongation reaction. Unlike the suspension polymerization method and the emulsion aggregation method, the polyester elongation method is also capable of using various kinds of resins. It is particularly advantageous that polyester resins, which are useful for a full-color toner capable of providing images with good transparency and smoothness, can be used therefor. In addition, the resultant toner may have a wide fixable temperature range, because viscoelasticity of the resultant toner can be controlled by the elongation reaction.

JP 3063269 and JP-A 08-211655 have disclosed a phase-inversion emulsification method. The phase-inversion emulsification method includes, for example, the following steps: dispersing or dissolving a binder resin and internal additives such as a colorant, a release agent, and a charge controlling agent in a low-boiling volatile organic solvent, to prepare an oily component liquid; continuously pouring an aqueous medium into the oily component liquid so that liquid droplets of the oily component liquid are formed by inverting a W/O dispersion into a O/W dispersion; and removing the volatile organic solvent from the dispersion. The phase-inversion emulsification method is also capable of using various kinds of resins. It is particularly advantageous that polyester resins, which are useful for a full-color toner capable of providing images with good transparency and smoothness, can be used therefor.

It is known that the chemical toner manufacturing methods provide toners capable of efficiently expressing a desired specific function, such as a capsulated toner and a core-shell toner, in consideration of recent environmental problems.

A toner manufactured by the chemical toner manufacturing methods (hereinafter referred to as a chemical toner) typically has a smaller particle diameter and a narrower particle diameter distribution compared to the pulverization toner. However, the chemical toner typically has a hydrophilic surface because of being granulated in water or an aqueous medium. Such a toner has poor chargeability, temporal stability, and environmental stability, and tends to cause development and/or transfer defect, toner scattering, deterioration of image quality, etc. Further, the chemical toner manufacturing method disadvantageously produces a large amount of waste liquid and requires a large amount of energy in drying toner particles, resulting in increase of environmental burdens.

In view of preventing deterioration of fluidity, transferability, and cleanability of the pulverization toner having a small particle diameter, and deterioration of chargeability, temporal stability, and environmental stability of the chemical toner having a hydrophilic surface, a typical technique proposed is one in which inorganic or organic fine particles are adhered to the surface of the toner so that adhesive property of the toner is reduced. This technique has another purpose of increasing fluidity of the toner so that the toner is efficiently transported from a toner container to a developing part in an image forming apparatus.

For example, JP-A 52-30437 discloses a toner including fine particles of a hydrophobic silica. JP-A 60-238847 discloses a toner including a mixture of fine particles of silica, aluminum oxide, and titanium oxide. JP-A 57-79961 discloses a developer including fine particles of titanium oxide covered with aluminum oxide. JP-A 60-112052 discloses a toner including fine particles of an anatase-type titanium oxide. JP-A 04-40467 discloses a toner including fine particles of a titanium oxide subjected to a surface treatment with a coupling agent. Typically, fine particles of silica are widely used because of having a high ability to impart fluidity, developability, and transferability to the toner. (The above-described materials may be hereinafter referred to as an external additive.)

The external additive tends to be buried in the surface of the toner or release therefrom with time, because mechanical stresses are successively applied to the toner in a transfer part, a cleaning part, etc., of a copier or a printer. Thereby, transfer efficiency and cleaning reliability of the toner deteriorate.

As an alternative to the pulverization and chemical methods, JP-A 2003-262976 discloses a toner manufacturing method in which microdroplets of fluid raw materials are formed using piezoelectric pulse, and the microdroplets are dried to become toner particles. JP-A 2003-280236 discloses a toner manufacturing method in which microdroplets of fluid raw materials are formed using thermal expansion in a liquid container, and the microdroplets are dried to become toner particles. JP-A 2003-262977 discloses a toner manufacturing method in which microdroplets of fluid raw materials are formed using an acoustic lens, and the microdroplets are dried to become toner particles.

When the fluid raw materials include a charge controlling agent, it may be difficult to stably discharge the fluid raw materials from fine discharge openings without clogging, in some cases. In these cases, the charge controlling agent needs to be finely dispersed in advance, or treated with a large amount of a dispersion stabilizer so as to be kept in a fine dispersion state for a predetermined amount of time. If the microdroplets are formed with an aqueous solvent, the resultant toner particles may have a hydrophilic surface. In order to prevent deterioration of chargeability, temporal stability, and environmental stability of such a toner having a hydrophilic surface, inorganic or organic fine particles need to be adhered to the surface of the toner similarity to the pulverization and chemical toners.

JP 3344003 discloses a method for producing spherical particles using a vibration orifice. International publication No. WO 03/000741 discloses a method for producing resin particles by application of mechanical vibration. JP-A 2006-77252 discloses ultrafine particles produced by a pressurized vibration injection granulation device. However, these methods are not yet applied to a manufacture of a toner.

JP-A 2006-293320 discloses a method for producing toner particles by application of mechanical vibration. However, the produced toner particles have unstable chargeability, depending on temporal and use environment.

As described above, a toner simultaneously having the following properties is not yet provided:
(1) a narrow particle diameter distribution;
(2) a good combination of toner properties such as chargeability, environmental stability, and temporal stability;
(3) not including residual monomers;
(4) manufactured without producing waste liquids;
(5) manufactured without a drying process; and
(6) manufactured at low cost.

### SUMMARY OF THE INVENTION

Accordingly, an object of the present invention is to provide a toner having good transferability, cleanability, fluidity, and chargeability and a narrow particle diameter distribution, which is manufactured at high manufacturing efficiency with less environmental load.

Another object of the present invention is to provide a developer and an image forming apparatus capable of forming high quality images regardless of environmental and temporal conditions

These and other objects of the present invention, either individually or in combinations thereof, as hereinafter will become more readily apparent can be attained by a toner, comprising:

a binder resin;

a colorant; and

a silicon-containing polymer,

wherein the toner is manufactured by a method comprising:
discharging a toner constituent liquid comprising toner constituents comprising the binder resin, the colorant, and the silicon-containing polymer, from at least one discharge opening to form liquid droplets thereof; and
converting the liquid droplets into solid toner particles in a granulation space;
   and a developer and an image forming apparatus using the toner.

### BRIEF DESCRIPTION OF THE DRAWINGS

These and other objects, features and advantages of the present invention will become apparent upon consideration of the following description of the preferred embodiments of the present invention taken in conjunction with the accompanying drawings, wherein:

FIG. 1 is a schematic view illustrating an embodiment of an apparatus for manufacturing the toner of the present invention;

FIG. 2 is a magnified view of a liquid droplet forming device of the apparatus illustrated in FIG. 1;

FIG. 3 is a schematic view illustrating another embodiment of an apparatus for manufacturing the toner of the present invention;

FIG. 4 is a magnified view of a liquid droplet forming device of the apparatus illustrated in FIG. 3;

FIG. 5 is an example of a SEM (scanning electron microscope) image of the toner of the present invention;

FIG. 6 is a schematic view illustrating an embodiment of a process cartridge used for the present invention;

FIG. 7 is a schematic view illustrating an embodiment of the image forming apparatus of the present invention;

FIG. 8 is a schematic view illustrating another embodiment of the image forming apparatus of the present invention; and

FIG. 9 is a schematic view illustrating an embodiment of an image forming unit of the image forming apparatus illustrated in FIG. 8.

### DETAILED DESCRIPTION OF THE INVENTION

Generally, the present invention provides a toner including a binder resin, a colorant, and a silicon-containing polymer. The toner is manufactured by discharging a toner constituent liquid including the binder resin, the colorant, and the silicon-containing polymer, from a discharge opening to form liquid droplets thereof, and subsequently converting the liquid droplets into solid toner particles in a granulation space.

When a mixture of raw materials of a toner include a specific silicon-containing compound, the silicon-containing compound tends to orient to the interface between air and the mixture of the raw materials which is in fluid state. As a result, a layer including a large amount of silicon atoms is formed on the surfaces of the resultant toner particles. Such toner particles have good transferability and cleanability even if a small amount of external additive is added thereto.

In particular, the silicon-containing polymer, which has good negative charge controlling ability, is dissolved in the toner constituent liquid. At a time liquid droplets of the toner constituent liquid, which is in fluid state, are formed and the liquid droplets are dried to become solid toner particles, the silicon-containing polymer chains are oriented so that the silicon atom is selectively moved and fixed to the surfaces of the resultant toner particles. Such toner particles having silicon atoms on the surfaces thereof have less adhesive properties. Therefore, such toner particles have good transferability and cleanability even if a small amount of external additive is added thereto. In addition, the resultant toner particles have good chargeability without deterioration of fixability.

Next, a method for manufacturing the toner of the present invention will be explained in detail.

The toner of the present invention is manufactured by discharging a toner constituent liquid, in which a binder resin, a colorant, and a silicon-containing polymer are dissolved or dispersed, from a discharge opening provided on a nozzle plate vibrated at a predetermined frequency, to form liquid droplets thereof; and subsequently drying the liquid droplets.

As described in a reference entitled “On the Instability of Jets (Rayleigh, Lord, Proc. London Math. Soc. 110:4 (1878))”, a wavelength λ which forms the most unstable liquid column is represented by the following equation:

λ=4.5d(jet) (1)

wherein d(jet) represents the diameter of a liquid column.

The frequency f of the generated disturbance is represented by the following equation:

f=v/λ (2)

wherein v represents the velocity of the liquid column.

As described in a reference entitled “Source of Uniform-Sized Liquid Droplets (J. M. Schneider, C. D. Hendricks, Rev. Instrum., 35(10), 1349-50 (1964))”, uniform-sized liquid droplets can be stably formed when the following relationship is satisfied:

3.5<λ/d(jet)<7.0 (3)

As described in a reference entitled “Production of uniform-sized liquid droplets (N. R. Lindblad, J. M. Schneider, J. Sci. Instrum., 42, 635 (1965))”, the minimum jet velocity V(min) in which a liquid discharged from an opening forms a liquid column is represented by the following equation, based on energy conservation law:

V(min)=(8σ/ρd(jet))^{1/2} (4)

wherein σ represents the surface tension of a liquid and ρ represents the density of the liquid.

The present inventors confirmed that the equations (1) to (4) may vary when the liquid component varies. However, the liquid-droplet-forming phenomenon is observed in various liquids when the liquid is vibrated at a frequency f by a vibration means provided in a liquid chamber.

An apparatus for manufacturing the toner of the present invention preferably includes a liquid droplet forming device configured to form liquid droplets of a toner constituent liquid including a binder resin and a colorant by discharging the toner constituent liquid from a nozzle plate vibrated at a predetermined frequency, and a toner particle forming device configured to form toner particles by drying the liquid droplets by removing a solvent therefrom. However, usable apparatuses are not limited thereto. The liquid droplet forming device preferably includes a vibration generating device configured to directly vibrate the nozzle plate. The vibration generating device preferably vibrates the nozzle plate at a time the toner constituent liquid passes through the nozzle plate. Further, the apparatus preferably includes a retention part configured to retain the toner constituent liquid and supply the toner constituent liquid to the liquid droplet forming device.

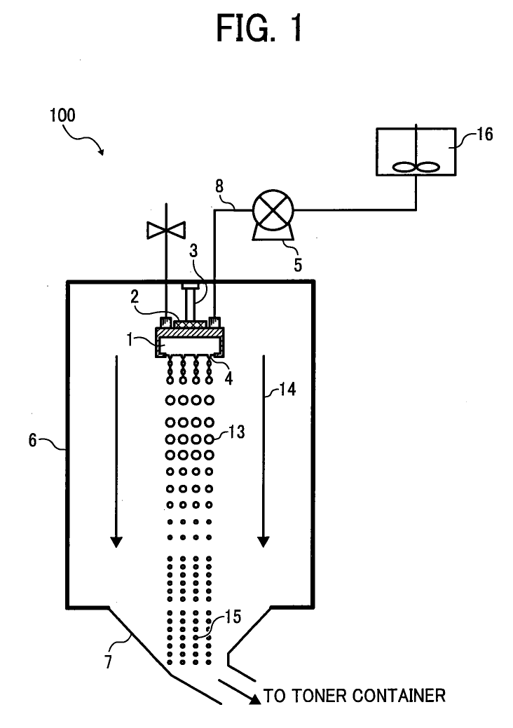

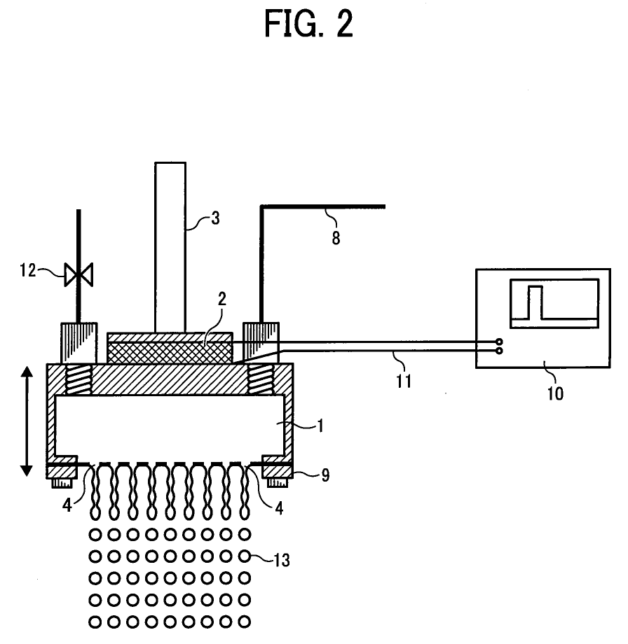

FIG. 1 is a schematic view illustrating an embodiment of an apparatus 100 for manufacturing the toner of the present invention. FIG. 2 is a magnified view of a liquid droplet forming device of the apparatus 100 illustrated in FIG. 1.

As illustrated in FIGS. 1 and 2, a retention part 1 retaining the toner constituent liquid including a silicon-containing polymer is preferably connected with a liquid supplying pipe 8 configured to supply the toner constituent liquid to the retention part 1 from the toner constituent liquid container 16, and preferably includes a housing 9 including discharge openings 4. A vibration device 2 configured to entirely vibrate the retention part 1 is in contact with the retention part 1. The vibration device 2 is preferably connected to a waveform generating device 10 with a lead wire 11. It is preferable that a drain 12 configured to drain a liquid from the retention part 1 is provided so that different kinds of products are efficiently manufactured.

The retention part 1 needs to retain the toner constituent liquid under pressure. Therefore, the retention part 1 is preferably made of a metallic material such as SUS and aluminum, and preferably has a resistance to a pressure of about 10 MPa, but is not particularly limited.

The vibration device 2 preferably includes a single vibration means and entirely vibrates the retention part 1 including the discharge openings 4. The vibration device 2 is not particularly limited so long as capable of applying a stable vibration at a specific frequency.

A piezoelectric substance has a function of converting electrical energy into mechanical energy. In particular, the piezoelectric substance expands and contracts upon application of voltage, and thereby the discharge openings 4 are vibrated. As the piezoelectric substance, for example, a piezoelectric ceramic such as lead zirconate titanate (PZT) can be used. Such a substance is often laminated because of typically having a small displacement. Other specific examples of the piezoelectric substance include, but are not limited to, piezoelectric polymers such as polyvinylidene fluoride (PVDF), and single crystals of quartz, LiNbO₃, LiTaO₃, KNbO₃, etc.

The vibration frequency is preferably from 50 kHz to 50 MHz, more preferably from 100 kHz to 10 MHz, and much more preferably from 200 kHz to 2 MHz, from the viewpoint of producing extremely uniform-sized liquid droplets.

The vibration device 2 is in contact with the retention part 1. The retention part 1 supports a nozzle plate including the discharge openings 4. From the viewpoint of uniformly vibrating liquid columns discharged from the discharge openings 4, the vibration device 2 and the nozzle plate including the discharge openings 4 are preferably arranged in parallel. The vibration device 2 and the nozzle plate preferably form an angle of not greater than 10° even if the relative position is changed due to the vibration.

Liquid droplets can be formed even if a single discharge opening 4 is provided. However, from the viewpoint of efficiently producing extremely uniform-sized liquid droplets, a plurality of the discharge openings 4 is preferably provided. The liquid droplets are preferably dried in a solvent removing device 6.

A support member 3 configured to support the vibration device 2 is provided so that the retention part 1 and the vibration device 2 are fixed to the apparatus 100. Rigid bodies such as metals are preferably used for the support member 3, but are not limited thereto. Rubber or polymer materials serving as a vibration absorbing material can be partially provided on the support member 3 if desired, so that the vibration of the retention part 1 is not disturbed by an undesired resonance.

The discharge openings 4 are configured to discharge a columnar toner constituent liquid. In order to produce extremely uniform-sized liquid droplets at a frequency of not less than 100 kHz without causing opening clogging with a dispersoid not greater than 1 μm, the discharge openings 4 are preferably formed on a metallic plate having a thickness of from 5 to 50 μm and preferably having an opening diameter of from 1 to 40 μm, but the material used and the shape thereof are not particularly limited. As the diameter of the opening increases, the frequency range in which liquid droplets are stably produced substantially narrows. Therefore, the frequency is preferably not less than 100 kHz considering manufacturability. The opening diameter represents the diameter when the opening is a perfect circle, and the minor diameter when the opening is an ellipse.

As a liquid supplying device 5, constant rate pumps such as a tube pump, a gear pump, a rotary pump, and a syringe pump are preferably used. In addition, pumps in which a liquid is fed by pressure of compressed air can also be used. The retention part 1 is filled with the toner constituent liquid supplied by the liquid supplying device 5, and thereby the liquid pressure is increased to the level capable of forming liquid droplets. The liquid pressure can be measured with a pressure gage or a pressure sensor attached to the pump.

The solvent removing device 6 configured to remove a solvent from liquid droplets 13 is not particularly limited. It is preferable that an airflow is formed by flowing a dried gas 14 (i.e., a gas having a dew point of not greater than −10° C. under atmospheric pressure) in the same direction as the liquid droplets 13 are discharged, so that the liquid droplets 13 are transported by the airflow in the solvent removing device 6. Thereby, the solvent is removed from the liquid droplets 13, resulting in formation of toner particles 15. Specific preferred examples of the dried gas 14 include air and nitrogen gas, but are not limited thereto.

A toner collection part 7 is provided on the bottom of the apparatus 100 in view of efficiently collecting and transporting the toner particles 15. The structure of the toner collection part 7 is not particularly limited. As illustrated in FIG. 1, the toner collection part 7 preferably includes a tapered part in which the opening diameter gradually decreases from the entrance to the exit thereof. The toner particles 15 are preferably transported from the exit of the tapered part to a toner container by riding an airflow of the dried gas 14.

As mentioned above, the toner particles 15 may be fed to the toner container by a pressure of the dried gas 14, or may be sucked from the toner container.

The airflow of the dried gas 14 is preferably a vortex which can generate centrifugal force to remove ultrafine particles.

The toner collection part 7 and the toner container are preferably made of a conductive material and grounded, in view of efficiently transporting the toner particles 15. The apparatus 100 is preferably explosion-proof.

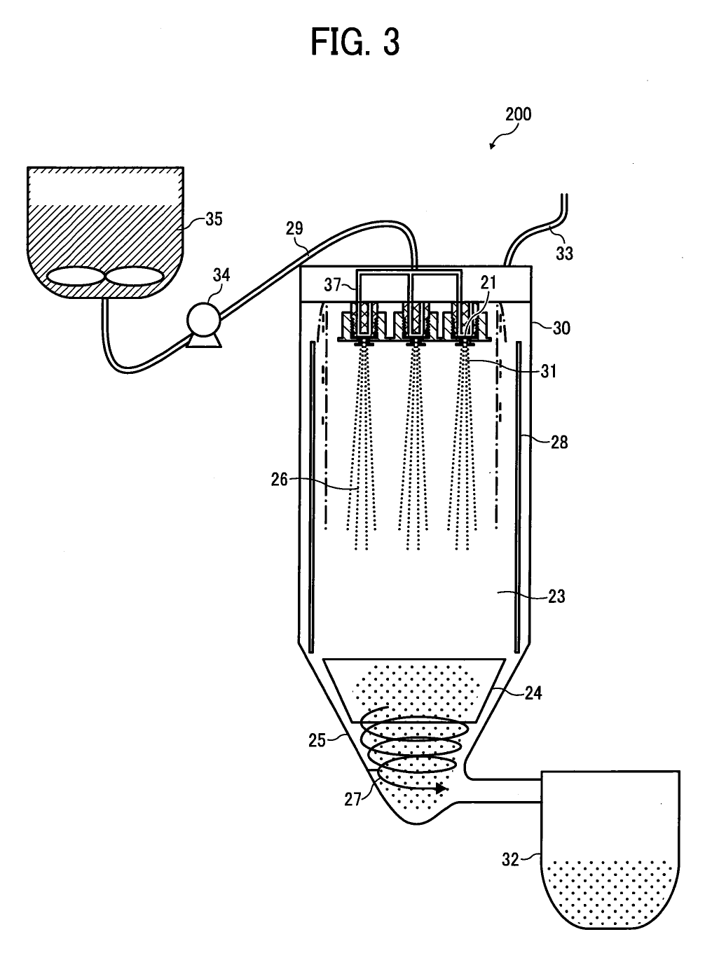

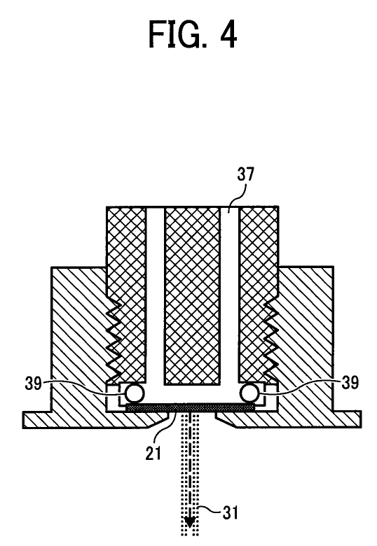

FIG. 3 is a schematic view illustrating another embodiment of an apparatus 200 for manufacturing the toner of the present invention. FIG. 4 is a magnified view of a liquid droplet forming device of the apparatus 200 illustrated in FIG. 3.

The apparatus 200 includes a toner constituent liquid container 35 and a drying chamber 30, which includes a liquid droplet forming device including a nozzle plate 21 and a toner particle forming device including a solvent removing device 23, a diselectrification device 24, and a toner collection part 25.

In the apparatus 200, a liquid supplying device 34 supplies a toner constituent liquid from the toner constituent liquid container 35 to a liquid supplying path 37 via a liquid supplying pipe 29, with controlling the amount of the toner constituent liquid supplied. Thereafter, the toner constituent liquid is discharged from discharge openings provided on the nozzle plate 21 to form liquid droplets 31. Subsequently, a solvent included in the liquid droplets 31 is removed therefrom in the solvent removing device 23 to form toner particles 26. The toner particles 26 are diselectrified by the diselectrification device 24, and subsequently collected into the toner collection part 25 by a vortex 27. The collected toner particles 26 are finally transported to a toner container 32.

The nozzle plate 21 is configured to discharge the toner constituent liquid to form liquid droplets thereof.

In order to produce extremely uniform-sized liquid droplets, the nozzle plate 21 is preferably made of a metallic plate having a thickness of from 5 to 50 μm and preferably including discharge openings having an opening diameter of from 3 to 35 μm. The opening diameter represents the diameter when the opening is a perfect circle, and the minor diameter when the opening is an ellipse.

The vibration frequency is preferably from 50 kHz to 50 MHz, more preferably from 100 kHz to 10 MHz, and much more preferably from 100 kHz to 450 kHz, from the viewpoint of producing extremely uniform-sized liquid droplets.

The nozzle plate 21 may include a single discharge opening. However, from the viewpoint of efficiently producing extremely uniform-sized liquid droplets, a plurality of the discharge openings is preferably provided. The liquid droplets 31 are preferably dried in the solvent removing device 23.

Referring to FIG. 4, an O-ring 39 is sandwiched between the nozzle plate 21 and the liquid supplying path 37. The toner constituent liquid is supplied to the liquid supplying path 37 so that the liquid droplets 31 are discharged to the drying chamber 30 by a dispersing air.

The number of discharge openings formed on the nozzle plate 21 is preferably from 1 to 5,000, more preferably from 1 to 2,000, and much more preferably from 200 to 1,500, so as to produce extremely uniform-sized liquid droplets.

The solvent removing device 23 configured to remove a solvent from the liquid droplets 31 is not particularly limited. It is preferable that an airflow is formed by flowing a dried gas (i.e., a gas having a dew point of not greater than −10° C. under atmospheric pressure) in the same direction as the liquid droplets 31 are discharged, so that the liquid droplets 31 are transported by the airflow in the solvent removing device 23. Thereby, the solvent is removed from the liquid droplets 31, resulting in formation of toner particles 26. Specific preferred examples of the dried gas include air and nitrogen gas, but are not limited thereto.

The dried gas may be flowed from a dried gas supplying pipe 33, for example.

The dried gas preferably has as high a temperature as possible, from the viewpoint of improving drying efficiency. In a spray drying, even if the dried gas has a temperature of not less than the boiling point of the solvent, the liquid droplets 31 are not heated to a temperature of not less than the boiling point of the solvent in the constant-drying-rate period. Therefore, the resultant toner particles 26 are not thermally damaged. However, the toner particles 26 tend to be thermally fused with each other when exposed to the dried gas having a temperature of not less than the boiling point of the solvent in the decreasing-drying-rate period (i.e., after the liquid droplets are dried), because the toner particles 26 are mainly composed of a thermoplastic resin. As a result, the particle diameter distribution of the toner particles 26 tends to deteriorate (broadens). In particular, the dried gas preferably has a temperature of from 40 to 200° C., more preferably from 60 to 150° C., and much more preferably from 75 to 85° C.

In order to prevent the liquid droplets 31 from adhering to the inner wall of the solvent removing device 23, an electric field curtain 28, which is charged to the reverse polarity of the liquid droplets 31, is preferably provided on the inner wall of the solvent removing device 23. Thereby, a transport path configured to pass the liquid droplets 31 is formed surrounded by the electric field curtain 28.

The diselectrification device 24 temporarily neutralizes charges of the toner particles 26, which are formed by passing the liquid droplets 31 through the transport path, so that the toner particles 26 are collected in the toner collection part 25.

A method for neutralizing the toner particles 26 is not particularly limited. For example, methods such as soft X-ray irradiation and plasma irradiation are preferable because the neutralization can be efficiently performed.

The toner collection part 25 is provided on the bottom of the apparatus 200 in view of efficiently collecting and transporting the toner particles 26.

The structure of the toner collection part 25 is not particularly limited. As illustrated in FIG. 3, the toner collection part 25 preferably includes a tapered part in which the opening diameter gradually decreases from the entrance to the exit thereof. The toner particles 26 are preferably transported from the exit of the tapered part to the toner container 32 by riding an airflow of the dried gas.

As mentioned above, the toner particles 26 may be fed to the toner container 32 by a pressure of the dried gas, or may be sucked from the toner container 32.

The airflow of the dried gas is preferably the vortex 27 which can generate centrifugal force to reliably transport the toner particles 26.

The toner collection part 25 and the toner container 32 are preferably made of a conductive material and grounded, in view of efficiently transporting the toner particles 26. The apparatus 200 is preferably explosion-proof.

The liquid droplets 31 are formed by discharging the toner constituent liquid from the nozzle plate 21 vibrated at a specific frequency. Suitable materials used for the toner constituent liquid will be explained later.

A method for preparing the toner constituent liquid is not particularly limited. For example, the toner constituent liquid may be prepared by melt-kneading a binder resin such as a styrene-acrylic resin, a polyester resin, a polyol resin, and an epoxy resin and a colorant, and dissolving the melt-kneaded mixture in an organic solvent to which the binder resin is soluble.

In the method for manufacturing a toner of the present invention, the number of liquid droplets discharged from the discharge openings formed on the nozzle plate 21 is from as much as several tens of thousands to several millions per second. It is also easy to increase the number of the discharge openings. Since the liquid droplets have a very uniform diameter and manufacturability thereof is good, this method is very suitable for manufacturing a toner. In this method, the particle diameter of the resultant toner can be accurately determined by the following equation, irrespective of material used for the toner:

Dp=(6QC/πf)^{1/3} (I)

wherein Dp represents the particle diameter of a solid particle (i.e., toner), Q represents the flow rate of a liquid (depending on the flow rate of the pump and the diameter of the discharge opening), C represents the volume concentration of solid components, and f represents the vibration frequency.

The particle diameter of the resultant toner can be much more easily determined by the following equation:

C=(Dp/Dd)³ (II)

wherein C (% by volume) represents the volume concentration of solid components, Dp represents the particle diameter of a solid particle (i.e., toner), and Dd represents the particle diameter of a liquid droplet.

The particle diameter of the liquid droplet 31 is twice as large as the opening diameter of the discharge opening formed on the nozzle plate 21, irrespective of the vibration frequency. Therefore, a solid particle having a desired particle diameter can be obtained by preparing a liquid including a specific amount of solid components calculated from the equation (II). For example, when the discharge opening has an opening diameter of 7.5 μm, the liquid droplet has a particle diameter of 15 μm. In this case, a solid particle having a particle diameter of 6.0 μm is obtained when the volume concentration of solid components is 6.40% by volume. The vibration frequency f is preferably as high as possible from the viewpoint of enhancing manufacturability. The flow rate Q of the liquid is determined from the equation (I) depending on the vibration frequency f.

In most conventional toner manufacturing methods, the particle diameter of the resultant toner largely depends on the kind of material used. In the above-described toner manufacturing method, particles having a desired particle diameter can be continuously produced by controlling the diameter of the discharged liquid droplet and the concentration of solid components.

Since a toner (i.e., mother toner) manufactured by the above-described toner manufacturing method has an extremely narrow particle diameter distribution, the toner has very high fluidity. Therefore, the toner has an advantage that a very small amount of an external additive is needed, in order to decrease the adherence to the toner manufacturing device, etc. In general, the usage of the external additive is preferably as small as possible considering the temporal deterioration of the toner due to reception of mechanical stress, and an effect of the external additive (i.e., fine particles) on the human body.

The toner of the present invention is manufactured by the above-described method, and has a nearly monodisperse particle diameter distribution.

The toner preferably has a particle diameter distribution (i.e., the ratio of the weight average particle diameter to the number average particle diameter) of from 1.00 to 1.10, and more preferably from 1.00 to 1.05, and a weight average particle diameter of from 1 to 6 μm.

Any materials conventionally used for a toner can be used for the toner of the present invention. For example, the toner of the present invention can be prepared by: dissolving or dispersing toner constituents including a binder resin, such as a styrene-acrylic resin, a polyester resin, a polyol resin, and an epoxy resin, a colorant, and a silicon-containing polymer in an organic solvent, to prepare a toner constituent liquid; discharging the toner constituent liquid from a discharge opening to form liquid droplets thereof; and drying the liquid droplets to form toner particles. Alternatively, the toner of the present invention can be prepared by: melt-kneading the above-described toner constituents to prepare a kneaded mixture; dissolving or dispersing the kneaded mixture in a solvent to prepare a toner constituent liquid; discharging the toner constituent liquid from a discharge opening to form liquid droplets thereof; and drying the liquid droplets to form toner particles. The silicon-containing polymer migrates to the surface of the resultant toner particles in the drying process.

Raw materials of the toner of the present invention include a binder resin, a colorant, and a silicon-containing polymer, and optionally includes a wax, a magnetic material, and the like, if desired. The raw materials are preferably dissolved or finely dispersed in an organic solvent to prepare a toner constituent liquid, which is treated as the raw materials in a liquid form.

Specific preferred examples of suitable organic solvents include, but are not limited to, monohydric alcohols, dihydric alcohols, aromatic hydrocarbons, aliphatic hydrocarbons, esters, ketones, alicyclic hydrocarbons, and volatile organopolysiloxanes. More specifically, specific examples of the organic solvents include, but are nor limited to, methanol, ethanol, 2-propanol, n-butanol, propylene glycol, toluene, xylene, isopentane, n-hexane, n-heptane, ethyl acetate, butyl acetate, acetone, methyl ethyl ketone, and cyclohexane.

Specific preferred examples of suitable silicon-containing polymers include, but are not limited to, silicone resins, silicone-acrylic resins, and silicone oils.

The silicon-containing polymer is preferably soluble in organic solvents. If the silicon-containing polymer is insoluble in organic solvents, a process for finely dispersing the silicon-containing polymer in an organic solvent, and a technique for maintaining the dispersion state are needed, so that the toner constituent liquid is stably discharged from the discharge opening without clogging.

The silicon-containing polymer is preferably in solid state at room temperature. If the silicon-containing polymer is in liquid state at room temperature, and further a large amount of the silicon-containing polymer in liquid state is included in the raw materials, the silicon-containing polymer in liquid state tends to bleed at the surface of the toner particle. Thereby, the adherence of the toner particle increases due to the liquid bridge force, resulting in deterioration of transferability of the toner particle.

Specific preferred examples of usable commercially available silicone resins include, but are not limited to, straight silicone resins KR271, KR255, KR220L, and KR152 (from Shin-Etsu Chemical Co., Ltd.), and 804 RESIN, 805 RESIN, 840 RESIN, SR 2400, SR 2406, SR 2410, 217 FLAKE RESIN, 220 FLAKE RESIN, 233 FLAKE RESIN, and 249 FLAKE RESIN (from Dow Coming Toray Co., Ltd.).

Modified silicone resins can also be used. Specific preferred examples of commercially available modified silicone resins include, but are not limited to, alkyd-modified silicone resins such as KR206 (from Shin-Etsu Chemical Co., Ltd.) and SR 2110 (from Dow Coming Toray Co., Ltd.), epoxy-modified silicone resins such as ES1001N (from Shin-Etsu Chemical Co., Ltd.) and SR 2115 (from Dow Coming Toray Co., Ltd.), urethane-modified silicone resins such as KR305 (from Shin-Etsu Chemical Co., Ltd.), and amino-modified silicone resins such as SF 8417, BY 16-850, and BY 16-872 (from Dow Coming Toray Co., Ltd.).

Further, polyether-modified silicone resins such as dimethylsiloxane-methyl(polyoxyethylene)siloxane-methyl(polyoxypropylene)siloxane copolymer, and polyoxyethylene-methylpolysiloxane copolymers (such as commercially available products SH 3771 M, SH 3772 M, SH 3773 M, and SH 3775 M (from Dow Coming Toray Co., Ltd.) and KF6004 (from Shin-Etsu Chemical Co., Ltd.)) can also be used.

Silicone-acrylic resins are preferably used because resin properties are easily variable by varying the kinds of monomers, the ratio of copolymerization, the molecular weight, etc.

Specific preferred examples of suitable silicone-acrylic resins include, but are not limited to, a commercially available product KR5208 (from Shin-Etsu Chemical Co., Ltd.) and copolymers obtained by copolymerizing a silicon-containing radical-polymerizable monomer and a monomer copolymerizable with the silicon-containing radical-polymerizable monomer.

Specific preferred examples of suitable silicon-containing radical-polymerizable monomers include a compound having the following formula (1):

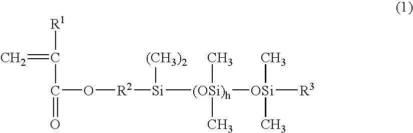

wherein R¹ represents a hydrogen atom or a methyl group; R² represents a divalent hydrocarbon group having 1 to 6 carbon atoms, which may have an oxygen atom in a main chain thereof; R³ represents an alkyl group having 1 to 30 carbon atoms, an aromatic group, or a hydroxyl group; and h represents an integer of from 1 to 200.

Usable commercially available silicon-containing radical-polymerizable monomers having the formula (1) include, but are not limited to, SILAPLANE FM-0711 (from Chisso Corporation; R¹=methyl group, R²=propylene group, h=10, and R³=butyl group in the formula (1)), SILAPLANE FM-0721 (from Chisso Corporation; R¹=methyl group, R₂=propylene group, h=62, and R³=butyl group in the formula (1)), SILAPLANE FM-0725 (from Chisso Corporation; R¹=methyl group, R²=propylene group, h=130, and R³=butyl group in the formula (1)), X-22-2475 (from Shin-Etsu Chemical Co., Ltd.; R¹=methyl group, R²=propylene group, h=2, and R³=methyl group in the formula (1)), X-22-174DX (from Shin-Etsu Chemical Co., Ltd.; R¹=methyl group, R²=propylene group, h=58, and R³=methyl group in the formula (1)), and X-22-2426 (from Shin-Etsu Chemical Co., Ltd.; R¹=methyl group, R²=propylene group, h=156, and R³=butyl group in the formula (1)).

The silicone-acrylic resin preferably includes a unit of the silicon-containing radical-polymerizable monomer having the formula (1) in an amount of from 5 to 60% by weight, more preferably from 15 to 55% by weight, and much more preferably from 25 to 50% by weight. When the amount is too small, the effect of the silicon atom is insufficient. When the amount is too large, the resultant copolymer has lower solubility to solvents.

Specific preferred examples of suitable silicon-containing radical-polymerizable monomers further include a compound having the following formula (2):

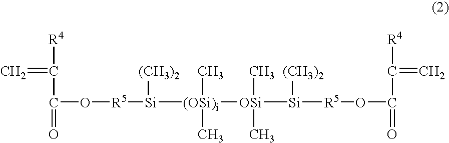

wherein R⁴ represents a hydrogen atom or a methyl group; R⁵ represents a divalent hydrocarbon group having 1 to 6 carbon atoms, which may have an oxygen atom in a main chain thereof; and i represents an integer of from 0 to 150.

Usable commercially available silicon-containing radical-polymerizable monomers having the formula (2) include, but are not limited to, SILAPLANE FM-7711 (from Chisso Corporation; R⁴=methyl group, R⁵=propylene group, and i=8 in the formula (2)), SILAPLANE FM-7721 (from Chisso Corporation; R⁴=methyl group, R⁵=propylene group, and i=60 in the formula (2)), SILAPLANE FM-7725 (from Chisso Corporation; R⁴=methyl group, R⁵=propylene group, and i=130 in the formula (2)), X-22-164 (from Shin-Etsu Chemical Co., Ltd.; R⁴=methyl group, R⁵=propylene group, and i=0 in the formula (2)), X-22-164AS (from Shin-Etsu Chemical Co., Ltd.; R⁴=methyl group, R⁵=propylene group, and i=7 in the formula (2)), X-22-164A (from Shin-Etsu Chemical Co., Ltd.; R⁴=methyl group, R⁵=propylene group, and i=18 in the formula (2)), X-22-164B (from Shin-Etsu Chemical Co., Ltd.; R⁴=methyl group, R⁵=propylene group, and i=40 in the formula (2)), X-22-164C (from Shin-Etsu Chemical Co., Ltd.; R⁴=methyl group, R⁵=propylene group, and i=60 in the formula (2)), and X-22-164E (from Shin-Etsu Chemical Co., Ltd.; R⁴=methyl group, R⁵=propylene group, and i=100 in the formula (2)).

The silicone-acrylic resin preferably includes a unit of the silicon-containing radical-polymerizable monomer having the formula (2) in an amount of from 5 to 60% by weight, more preferably from 15 to 55% by weight, and much more preferably from 25 to 50% by weight. When the amount is too small, the effect of the silicon atom is insufficient. When the amount is too large, the resultant copolymer has lower solubility to solvents.

Specific preferred examples of suitable silicon-containing radical-polymerizable monomers further include a compound having the following formula (3):

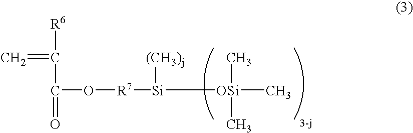

wherein R⁶ represents a hydrogen atom or a methyl group; R⁷ represents a divalent hydrocarbon group having 1 to 6 carbon atoms, which may have an oxygen atom in a main chain thereof; and j represents an integer of 0, 1, or 2.

Specific examples of the silicon-containing radical-polymerizable monomers having the formula (3) include, but are not limited to, γ-acryloxypropyltrimethoxysilane, γ-methacryloxypropyltrimethoxysilane, γ-acryloxypropylmethyldimethoxysilane, γ-methacryloxypropylmethyldimethoxysilane, γ-acryloxypropyldimethylmethoxysilane, γ-methacryloxypropyldimethylmethoxysilane, γ-acryloxypropyltriethoxysilane, γ-methacryloxypropyltriethoxysilane, γ-acryloxypropylmethyldiethoxysilane, γ-methacryloxypropylmethyldiethoxysilane, γ-acryloxypropyldimethylethoxysilane, and γ-methacryloxypropyldimethylethoxysilane.

Usable commercially available silicon-containing radical-polymerizable monomers having the formula (3) include, but are not limited to, SILAPLANE TM-0701 and TM-0701T (γ-methacryloxypropyltrimethoxysilane from Chisso Corporation; R⁶=methyl group and R⁷=propylene group in the formula (3)), X-22-2404 (from Shin-Etsu Chemical Co., Ltd.), and BX 16-122A and BY 16-122A (from Dow Coming Toray Co., Ltd.).

Specific preferred examples of suitable silicon-containing radical-polymerizable monomers further include, but are not limited to, vinyltrimethoxysilane, vinylmethyldimethoxysilane, vinyltriethoxysilane, vinylmethyldiethoxysilane, trimethoxysilylstyrene, dimethoxymethylsilylstyrene, triethoxysilylstyrene, and diethoxymethylsilylstyrene.

The silicone-acrylic resin preferably includes a unit of the silicon-containing radical-polymerizable monomer having the formula (3) in an amount of from 10 to 80% by weight, more preferably from 15 to 70% by weight, and much more preferably from 20 to 60% by weight. When the amount is too small, the effect of the silicon atom is insufficient. When the amount is too large, the resultant copolymer has lower solubility to solvents.

Specific examples of unsaturated monomers copolymerizable with the silicon-containing radical-polymerizable monomer include, but are not limited to, alkyl(meth)acrylates having an alkyl group having 4 or more carbon atoms such as n-butyl(meth)acrylate, t-butyl(meth)acrylate, isobutyl(meth)acrylate, 2-ethylhexyl(meth)acrylate, lauryl(meth)acrylate, hexyl(meth)acrylate, and octyl(meth)acrylate. These monomers are preferable from the viewpoint of solubility to organic solvents of the resultant copolymer.

Specific preferred examples of suitable polymerization initiator used for the copolymerization include, but are not limited to, organic peroxides and azo compounds.

Specific examples of the organic peroxides include, but are not limited to, isobutyl peroxide, lauroyl peroxide, 3,5,5-trimethylhexanoyl peroxide, octanoyl peroxide, t-butyl cumyl peroxide, benzoyl peroxide, dichlorobenzoyl peroxide, dicumyl peroxide, di-t-butyl peroxide, 1,1-bis(t-butylperoxy)-3,3,5-trimethylcyclohexane, 3,3,5-trimethylcyclohexanone peroxide, methylcyclohexanone peroxide, diisobutylperoxy dicarbonate, 2-diethylhexylperoxy dicarbonate, 2,5-dimethyl-2,5-bis(2-ethylhexanoylperoxy)hexane, 1,1-bis(t-hexylperoxy)-3,3,5-trimethylcyclohexane, 1,1-bis(t-hexylperoxy)cyclohexane, 1,1-bis(t-butylperoxy)cyclohexane, 2,2-bis(t-butylperoxy)butane, t-butyl hydroperoxide, cumene hydroperoxide, diisopropylbenzene hydroperoxide, methyl ethyl ketone peroxide, cyclohexanone peroxide, t-butylperoxy-2-ethylhexanoate, 1,1,3,3-tetramethylbutylperoxy-2-ethylhexanoate, t-hexylperoxy-2-ethylhexanoate, and t-butylperoxyisobutylate.

Specific examples of the azo compounds include, but are not limited to, 2,2′-azobis-isobutyronitrile, dimethylazodiisobutyrate, 2,2-azobis(2,4-dimethylvaleronitrile), 2,2′-azobis(2-methylbutyronitrile), 2,2′-azobis(4-methoxy-2,4-dimethylvaleronitrile), (1-phenylethyl)azodiphenylmethane, dimethyl-2,2′-azobisisobutyrate, 1,1′-azobis(1-cyclohexanecarbonitrile), 2,2′-azobis(2,2,4-trimethylpentane), 2-phenylazo-2,4-dimethyl-4-methoxyvaleronitrile, and 2,2′-azobis(2-methylpropane).

These polymerization initiators can be used alone or in combination.

The used amount of the polymerization initiator depends on the desired molecular weight of the resultant copolymer. Typically, the used amount of the polymerization initiator is preferably from 0.05 to 5.0% by weight based on the total amount of polymerizable monomers used. In order to control the molecular weight of the resultant polymer, a chain transfer agent can be used. Specific examples of the chain transfer agent include, but are not limited to, n-dodecyl mercaptan, γ-mercaptopropyltrimethoxysilane, γ-mercaptopropylmethyldimethoxysilane, and γ-mercaptopropyltriethoxysilane.

The copolymer is preferably obtained by a solution polymerization, in which a polymerizable unsaturated monomer is polymerized in an organic solvent in the presence of a polymerization initiator. This is because the organic solvent including the resultant polymer can be directly used for the toner constituent liquid without being treated. Suitable organic solvents for use in the solution polymerization include the above-described suitable organic solvents used for the toner constituent liquid. The amount of the organic solvent used for preparing the copolymer is preferably from 25 to 400 parts by weight, and more preferably from 40 to 250 parts by weight, based on 100 parts by weight of the polymerizable unsaturated monomers. When the amount is too small, the reactant may have too high a viscosity, and therefore the polymerization reaction may be suppressed. Moreover, the produced liquid also may have too high a viscosity. When the amount is too large, the produced liquid may have too low a concentration of the resin, and therefore the toner constituent liquid may not have a desired concentration on a solid basis. The reaction temperature is preferably 60 to 160° C., and the reaction time is preferably from 1 to 12 hours.

The silicone-acrylic copolymer preferably has a weight average molecular weight of from 2,000 to 1,000,000, and more preferably from 5,000 to 800,000, when measured by GPC based on polystyrene. When the weight average molecular weight is too small, an external additive may release from the surface of the toner while being agitated in a machine. When the weight average molecular weight is too large, the solubility to organic solvents may deteriorate.

Specific preferred examples of suitable silicone oils include, but are not limited to, dimethyl silicone oils such as polymethylsiloxane (e.g., SH 200 from Dow Coming Toray Co., Ltd., KF96 from Shin-Etsu Chemical Co., Ltd.); cyclic silicone oils such as octamethylcyclotetrasiloxane, decamethylcyclopentasiloxane, and dodecamethylcyclohexasiloxane (e.g., SH 244, SH 245, and DC 345 from Dow Coming Toray Co., KF955 from Shin-Etsu Chemical Co., Ltd.); and methylphenyl silicone oils such as methylphenylpolysiloxane (e.g., SH 510, SH 550, and SH 710 from Dow Coming Toray Co., KF50, KF53, KF54, and KF 56 from Shin-Etsu Chemical Co., Ltd.).

The silicone oil preferably has a viscosity not less than 100 cs, because a silicone oil having too small a viscosity tends to separate shortly after being emulsified in the toner constituent liquid. In contrast, the silicone oil preferably has a viscosity not greater than 10,000 cs, because a silicone oil having too large a viscosity is difficult to emulsify.

The binder resin is preferably capable of increasing its viscoelasticity by the action of a reactive substance. For example, a covalent bond, an ionic bond, and a hydrogen bond may be formed by the action. Specific preferred examples of suitable binder resins include, but are not limited to, styrene resins, vinyl polymers and copolymers of acrylic monomers, acrylate monomers, methacrylic monomers, and methacrylate monomers, polyester resins, polyol resins, phenol resins, silicone resins, polyurethane resins, polyamide resins, furan resins, epoxy resins, xylene resins, terpene resins, coumarone-indene resins, polycarbonate resins, and petroleum resins.

Specific examples of the styrene resins include, but are not limited to, homopolymers of styrene or styrene derivatives (e.g., polystyrene, poly-p-chlorostyrene, polyvinyl toluene) and styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer).

Specific examples of acrylic resins include, but are not limited to, polymethyl methacrylate and polybutyl methacrylate.

Furthermore, polyvinyl chloride, polyvinyl acetate, polyethylene, polypropylene, polyester, epoxy resins, epoxy polyol resins, polyurethane, polyamide, polyvinyl butyral, polyacrylic acid resins, rosin, modified rosin, terpene resins, phenol resins, aliphatic and alicyclic hydrocarbon resins, aromatic petroleum resins, chlorinated paraffin, and paraffin waxes can be used as the binder resin.

Specific examples of the acrylic and acrylate monomers include, but are not limited to, acrylic acids and esters thereof such as acrylic acid, methyl acrylate, ethyl acrylate, propyl acrylate, n-butyl acrylate, isobutyl acrylate, n-octyl acrylate, n-dodecyl acrylate, 2-ethylhexyl acrylate, stearyl acrylate, 2-chloroethyl acrylate, and phenyl acrylate.

Specific examples of the methacrylic and methacrylate monomers include, but are not limited to, methacrylic acids and esters thereof such as methacrylic acid, methyl methacrylate, ethyl methacrylate, propyl methacrylate, n-butyl methacrylate, isobutyl methacrylate, n-octyl methacrylate, n-dodecyl methacrylate, 2-ethylhexyl methacrylate, stearyl methacrylate, phenyl methacrylate, dimethylaminoethyl methacrylate, and diethylaminoethyl methacrylate.

Specific examples of other vinyl monomers include, but are not limited to, the following compounds:
(1) halogenated vinyl compounds such as vinyl chloride, vinylidene chloride, vinyl bromide, and vinyl fluoride;
(2) vinyl esters such as vinyl acetate, vinyl propionate, and vinyl benzoate;
(3) vinyl ethers such as vinyl methyl ether, vinyl ethyl ether, and vinyl isobutyl ether;
(4) vinyl ketones such as vinyl methyl ketone, vinyl hexyl ketone, and methyl isopropenyl ketone;
(5) N-vinyl compounds such as N-vinylpyrrole, N-vinylcarbazole, N-vinylindole, and N-vinylpyrrolidone;
(6) vinylnaphthalenes;
(7) derivatives of acrylic acid or methacrylic acid such as acrylonitrile, methacrylonitrile, and acrylamide;
(8) unsaturated dibasic acids such as maleic acid, citraconic acid, itaconic acid, alkenyl succinic acid, fumaric acid, and mesaconic acid;
(9) unsaturated dibasic acid anhydrides such as maleic acid anhydride, citraconic acid anhydride, itaconic acid anhydride, and alkenyl succinic acid anhydride;
(10) unsaturated dibasic acid monoesters such as monomethyl maleate, monoethyl maleate, monobutyl maleate, monomethyl citraconate, monoethyl citraconate, monobutyl citraconate, monomethyl itaconate, monomethyl alkenyl succinate, monomethyl fumarate, and monomethyl mesaconate;
(11) unsaturated dibasic acid esters such as dimethyl maleate and dimethyl fumarate;
(12) α,β-unsaturated acids such as crotonic acid and cinnamic acid;
(13) α,β-unsaturated acid anhydrides such as crotonic acid anhydride and cinnamic acid anhydride;
(14) anhydrides of α,β-unsaturated acids with lower fatty acids; anhydrides of alkenyl malonic acid, alkenyl glutaric acid, and alkenyl adipic acid; and monoester-like monomers thereof having a carboxyl group;
(15) hydroxyalkyl acrylates and methacrylates such as 2-hydroxyethyl acrylate, 2-hydroxyethyl methacrylate, and 2-hydroxypropyl methacrylate; and
(16) monomers having a hydroxyl group such as 4-(1-hydroxy-1-methylbutyl)styrene and 4-(1-hydroxy-1-methylhexyl)styrene.

Specific examples of styrene monomers include, but are not limited to, styrenes such as styrene, o-methylstyrene, m-methylstyrene, p-methylstyrene, p-phenylstyrene, p-ethylstyrene, 2,4-dimethylstyrene, p-n-amylstyrene, p-tert-butylstyrene, p-n-hexylstyrene, p-n-octylstyrene, p-n-nonylstyrene, p-n-decylstyrene, p-n-dodecylstyrene, p-methoxystyrene, p-chlorostyrene, 3,4-dichlorostyrene, m-nitrostyrene, o-nitrostyrene, and p-nitrostyrene; and derivatives thereof.

Specific examples of other vinyl monomers further include, but are not limited to, monoolefins such as ethylene, propylene, butylene, and isobutylene, and polyenes such as butadiene and isoprene.

The vinyl homopolymers and copolymers of the vinyl monomers may have a cross-linked structure formed using a cross-linking agent having 2 or more vinyl groups. Specific examples of the cross-linking agents having 2 or more vinyl groups include, but are not limited to, aromatic divinyl compounds such as divinylbenzene and divinylnaphthalene; diacrylate compounds in which acrylates are bound together with an alkyl chain (e.g., ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate); diacrylate compounds in which acrylates are bound together with an alkyl chain having an ether bond (e.g., diethylene glycol diacrylate, triethylene glycol diacrylate, tetraethylene glycol diacrylate, polyethylene glycol #400 diacrylate, polyethylene glycol #600 diacrylate, dipropylene glycol diacrylate); diacrylate compounds in which acrylates are bound together with a chain having an aromatic group and an ether bond; polyester diacrylate compounds such as MANDA (from Nippon Kayaku Co., Ltd.); and similar compounds as the above-described compounds except for replacing each acrylate therein with methacrylate.

The amount of the cross-linking agent is preferably 0.01 to 2 parts by weight, and more preferably 0.03 to 1 parts by weight based on 100 parts by weight of the monomer. In view of imparting good fixability and hot offset resistance to the resultant toner, aromatic divinyl compounds (particularly divinylbenzene) and diacrylate compounds in which acrylates are bound together with a chain having an aromatic group and an ether bond are preferably used. Among the above monomers, combinations of monomers which can produce styrene-acrylic copolymers are preferably used.

When the amount of the cross-linking agent is too large, insoluble components may be produced in the toner constituent liquid. In this case, discharge openings may be clogged with the toner constituent liquid, and therefore liquid droplets cannot be stably formed.

Specific examples of polymerization initiators used for polymerization of the vinyl polymers and copolymers include, but are not limited to, 2,2′-azobisisobutyronitrile, 2,2′-azobis(4-methoxy-2,4-dimethylvaleronitrile), 2,2′-azobis(2,4-dimethylvaleronitrile), 2,2′-azobis(2-methylbutyronitrile), dimethyl-2,2′-azobis isobutyrate, 1,1′-azobis(1-cyclohexanecarbonitrile), 2-(carbamoylazo)-isobutyronitrile, 2,2′-azobis(2,4,4-trimethylpentane), 2-phenylazo-2′,4′-dimethyl-4′-methoxyvaleronitrile, 2,2′-azobis(2-methylpropane), ketone peroxides (e.g., methyl ethyl ketone peroxide, acetylacetone peroxide, cyclohexanone peroxide), 2,2-bis(tert-butylperoxy)butane, tert-butyl hydroperoxide, cumene hydroperoxide, 1,1,3,3-tetramethylbutyl hydroperoxide, di-tert-butyl peroxide, tert-butylcumyl peroxide, di-cumyl peroxide, α-(tert-butylperoxy)isopropylbenzene, isobutyl peroxide, octanoyl peroxide, decanoyl peroxide, lauroyl peroxide, 3,5,5-trimethylhexanoyl peroxide, benzoyl peroxide, m-tolyl peroxide, di-isopropylperoxy dicarbonate, di-2-ethylhexylperoxy dicarbonate, di-n-propylperoxy dicarbonate, di-2-ethoxyethylperoxy carbonate, di-ethoxyisopropylperoxy dicarbonate, di(3-methyl-3-methoxybutyl)peroxy carbonate, acetylcyclohexylsulfonyl peroxide, tert-butylperoxy acetate, ter-butylperoxy isobutylate, tert-butylperoxy-2-ethylhexanoate, tert-butylperoxy laurate, tert-butyloxy benzoate, tert-butylperoxy isopropyl carbonate, di-tert-butylperoxy isophthalate, tert-butylperoxy allyl carbonate, isoamylperoxy-2-ethylhexanoate, di-tert-butylperoxy hexahydroterephthalate, and tert-butylperoxy azelate.

When the binder resin is a styrene-acrylic resin, THF-soluble components of the styrene-acrylic resin preferably has a molecular weight distribution such that at least one peak is present in each of a number average molecular weight range of from 3,000 to 50,000 and that of not less than 100,000, determined by GPC. In this case, the resultant toner has good fixability, offset resistance, and preservability. A binder resin including THF-soluble components having a molecular weight of not greater than 100,000 in an amount of from 50 to 90% is preferably used. A binder resin having a molecular weight distribution such that a main peak is present in a molecular weight range of from 5,000 to 30,000 is more preferably used. A binder resin having a molecular weight distribution such that a main peak is present in a molecular weight range of from 5,000 to 20,000 is much more preferably used.

Polyester resins are preferably used because of having better preservability and lower melt viscosity compared to styrene resins and acrylic resins. The polyester resin is obtainable by a polycondensation reaction between an alcohol and a carboxylic acid, for example.

Specific examples of the alcohols for preparing the polyester resins include, but are not limited to, diols such as polyethylene glycol, diethylene glycol, triethylene glycol, 1,2-propylene glycol, 1,3-propylene glycol, 1,4-propylene glycol, neopentyl glycol, and 1,4-butenediol; etherified bisphenols such as 1,4-bis(hydroxymethyl)cyclohexane, bisphenol A, hydrogenated bisphenol A, polyoxyethylenated bisphenol A, polyoxypropylenated bisphenol A; divalent alcohols in which the above-described compounds are substituted with a saturated or unsaturated hydrocarbon group having 3 to 22 carbon atoms; other divalent alcohols; and polyols having 3 or more valences such as sorbitol, 1,2,3,6-hexanetetrol, 1,4-sorbitan, pentaerythritol, dipentaerythritol, tripentaerythritol, sucrose, 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

Specific examples of the carboxylic acids for preparing the polyester resins include, but are not limited to, monocarboxylic acids such as palmitic acid, stearic acid, and oleic acid; dicarboxylic acids such as maleic acid, fumaric acid, mesaconic acid, citraconic acid, terephthalic acid, cyclohexanedicarboxylic acid, succinic acid, adipic acid, sebacic acid, and malonic acid; divalent organic acids in which the above-described compounds are substituted with a saturated or unsaturated hydrocarbon group having 3 to 22 carbon atoms; anhydrides of the above-described compounds; dimers of lower alkyl esters with linoleic acid; and polycarboxylic acids having 3 or more valences such as 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, and 1,2,7,8-octanetetracarboxylic acid, and anhydrides thereof.

When the binder resin includes too large an amount of a polyol and a polycarboxylic acid each having 3 or more valences, insoluble components may be produced in the toner constituent liquid. In this case, discharge openings may be clogged with the toner constituent liquid, and therefore liquid droplets cannot be stably formed.

When the binder resin is a polyester resin, THF-soluble components of the polyester resin preferably have a molecular weight distribution such that at least one peak is present in a number average molecular weight range of from 3,000 to 50,000, determined by GPC. In this case, the resultant toner has good fixability and offset resistance. A binder resin including THF-soluble components having a molecular weight of not greater than 50,000 in an amount of from 70 to 100% is preferably used. A binder resin having a molecular weight distribution such that at least one peak is present in a molecular weight range of from 5,000 to 20,000 is more preferably used. When a binder resin includes too large an amount of THF-soluble components having a molecular weight of not greater than 50,000, the binder resin has poor solubility to organic solvents. In this case, it takes too long a time to prepare the toner constituent liquid. Furthermore, discharge openings may be clogged with the toner constituent liquid, and therefore liquid droplets cannot be stably formed.

When the binder resin is a polyester resin, the resin preferably has an acid value of from 0.1 to 40 mgKOH/g, more preferably from 0.1 to 30 mgKOH/g, and much more preferably from 0.1 to 20 mgKOH/g. When the acid value is too large, the binder resin has poor solubility to organic solvents. In this case, it takes too long a time to prepare the toner constituent liquid. Furthermore, discharge openings may be clogged with the toner constituent liquid, and therefore liquid droplets cannot be stably formed.

Specific examples of the epoxy resins include, but are not limited to, polycondensation products of bisphenol A with epichlorohydrin. Specific examples of usable commercially available epoxy resins include, but are not limited to, EPOMIK R362, R364, R365, R633, R367, and R369 (from Mitsui Chemicals, Inc.); EPOTOHTO YD-011, YD-012, YD-014, YD-904, and YD-017 (from Tohto Kasei Co., Ltd.); and EPIKOTE 1002, 1004, and 1007 (from Shells Chemicals Japan Ltd.). A terminal epoxy group of the above-described epoxy resins may be sealed with a phenol compound such as cumylphenol and an alkylphenol.

Specific preferred examples of suitable binder resins further include a resin including a vinyl polymer unit and a polyester resin unit, at least one of which includes a unit of a monomer capable of reacting with both the vinyl polymer unit and the polyester resin unit. Specific examples of monomers constituting the polyester resin unit and capable of reacting with the vinyl polymer unit include, but are not limited to, unsaturated dicarboxylic acids such as phthalic acid, maleic acid, citraconic acid, and itaconic acid, and anhydrides thereof. Specific examples of monomers constituting the vinyl polymer unit and capable of reacting with the polyester resin unit include, but are not limited to, monomers having carboxyl group or hydroxyl group, and acrylates and methacrylates.

The number average molecular weight and the weight average molecular weight of a binder resin can be determined by GPC under the following conditions, for example.

Instrument: GPC-150C (from Waters Corporation)

Column: Shodex® KF801-807 (from Showa Denko K. K.)

Temperature: 40° C.

Solvent: THF (Tetrahydrofuran)

Flow rate: 1.0 ml/min

Sample: 0.1 ml of a sample with a concentration of 0.05 to 0.6% is injected

The number average molecular weight and the weight average molecular weight of a binder resin are calculated from a molecular weight correction curve obtained from a monodisperse polystyrene standard sample.

In the present invention, the acid value of a binder resin of a toner is determined by the following method according to JIS K-0070.

In order to prepare a sample, toner components except the binder resin are previously removed from the toner. Alternatively, if the toner is directly used as a sample, the acid value and weight of the toner components except the binder resin (such as a colorant and a magnetic material) are previously measured, and then the acid value of the binder resin is calculated.
(1) 0.5 to 2.0 g of a pulverized sample is precisely weighed;
(2) the sample is dissolved in 150 ml of a mixture of toluene and ethanol, mixing at a volume ratio of 4/1, in a 300 ml beaker;
(3) the mixture prepared above and the blank each are titrated with a 0.1 mol/l ethanol solution of KOH using a potentiometric titrator; and
(4) the acid value of the sample is calculated from the following equation:

AV=[(S−B)×f×5.61]/W

wherein AV (mgKOH/g) represents an acid value, S (ml) represents the amount of the ethanol solution of KOH used for the titration of the sample, B (ml) represents the amount of the ethanol solution of KOH used for the titration of the blank, f represents the factor of KOH, and W (g) represents the weight of the binder resin included in the sample.

Each of the binder resin and the toner including the binder resin preferably has a glass transition temperature (Tg) of from 35 to 80° C., and more preferably from 40 to 75° C., from the viewpoint of enhancing preservability of the toner. When the Tg is too small, the toner tends to deteriorate under high temperature atmosphere and cause offset when fixed. When the Tg is too large, fixability of the toner deteriorates.

Specific examples of colorants for use in the toner of the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone, etc. These materials can be used alone or in combination.

The colorant may be finely dispersed in an organic solvent in the presence of a dispersing agent by using a ball mill or a bead mill. A master batch, to be explained later, may also be dissolved and dispersed in an organic solvent.

The toner preferably includes a colorant in an amount of from 1 to 15% by weight, and more preferably from 3 to 10% by weight. When the amount is too small, coloring power of the toner may deteriorate. When the amount is too large, dispersibility of the colorant in the resultant toner may deteriorate, resulting in deterioration of coloring power and electric properties of the toner.

The colorant can be combined with a resin to be used as a master batch. The master batch may include a colorant dispersing agent, if desired. Specific examples of the resin for use in the master batch include, but are not limited to, polyester resins, polymers of styrenes and substituted styrenes (e.g., polystyrene, poly-p-chlorostyrene, polyvinyl toluene), styrene copolymers (e.g., styrene-p-chlorostyrene copolymer, styrene-propylene copolymer, styrene-vinyltoluene copolymer, styrene-vinylnaphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl α-chloromethacrylate copolymer, styrene-acrylonitrile copolymer, styrene-vinyl methyl ether copolymer, styrene-vinyl methyl ketone copolymer, styrene-butadiene copolymer, styrene-isoprene copolymer, styrene-acrylonitrile-indene copolymer, styrene-maleic acid copolymer, styrene-maleate copolymer), acrylic resins (e.g., polymethyl methacrylate, polybutyl methacrylate), polyvinyl chloride, polyvinyl acetate, polyethylene, polypropylene, polyester, epoxy resins, epoxy polyol resins, polyurethane, polyamide, polyvinyl butyral, polyacrylic acid resins, rosin, modified rosin, terpene resins, aliphatic or alicyclic hydrocarbon resins, aromatic petroleum resins, chlorinated paraffin, and paraffin waxes. These resins can be used alone or in combination.

The master batches can be prepared by mixing one or more of the resins as mentioned above and the colorant as mentioned above and kneading the mixture while applying a high shearing force thereto. In this case, an organic solvent can be added to increase the interaction between the colorant and the resin. In addition, a flushing method in which an aqueous paste including a colorant and water is mixed with a resin dissolved in an organic solvent and kneaded so that the colorant is transferred to the resin side (i.e., the oil phase), and then the organic solvent (and water, if desired) is removed, can be preferably used because the resultant wet cake can be used as it is without being dried. When performing the mixing and kneading process, dispersing devices capable of applying a high shearing force such as three roll mills can be preferably used.

The toner preferably includes the master batch in an amount of from 0.1 to 20 parts by weight based on 100 parts by weight of the binder resin.

The colorant dispersing agent preferably has high compatibility with the binder resin in order to well disperse the colorant. Specific examples of useable commercially available colorant dispersing agents include, but are not limited to, AJISPER® PB-821 and PB-822 (from Ajinomoto-Fine-Techno Co., Inc.), DISPERBYK®-2001 (from BYK-Chemie Gmbh), and EFKA® 4010 (from EFKA Additives BV).

The colorant dispersing agent preferably has a weight average molecular weight, which is a local maximum value of the main peak observed in the molecular weight distribution measured by GPC (gel permeation chromatography) and converted from the molecular weight of styrene, of from 500 to 100,000, more preferably from 3,000 from 100,000, from the viewpoint of enhancing dispersibility of the colorant. In particular, the average molecular weight is preferably from 5,000 to 50,000, and more preferably from 5,000 to 30,000. When the average molecular weight is too small, the dispersing agent has too high a polarity, and therefore dispersibility of the colorant deteriorates. When the average molecular weight is too large, the dispersing agent has too high an affinity for the solvent, and therefore dispersibility of the colorant deteriorates.

The toner preferably includes the colorant dispersing agent in an amount of from 1 to 50 parts by weight, and more preferably from 5 to 30 parts by weight, based on 100 parts by weight of the colorant. When the amount is too small, the colorant cannot be well dispersed. When the amount is too large, chargeability of the resultant toner deteriorates.

The toner of the present invention may include a wax.

Any known waxes can be used for the toner of the present invention. Specific examples of the waxes include, but are not limited to, aliphatic hydrocarbon waxes (e.g., low-molecular-weight polyethylene, low-molecular-weight polypropylene, polyolefin wax, microcrystalline wax, paraffin wax, SASOL wax), oxides of aliphatic hydrocarbon waxes (e.g., polyethylene oxide wax) and copolymers thereof, plant waxes (e.g., candelilla wax, carnauba wax, haze wax, jojoba wax), animal waxes (e.g., bees wax, lanoline, spermaceti wax), mineral waxes (e.g., ozokerite, ceresin, petrolatum), waxes including fatty acid esters (e.g., montanic acid ester wax, castor wax) as a main component, and partially or completely deacidified fatty acid esters (e.g., deacidified carnauba wax).

In addition, the following compounds can also be used: saturated straight-chain fatty acids (e.g., palmitic acid, stearic acid, montanic acid, and other straight-chain alkyl carboxylic acid), unsaturated fatty acids (e.g., brassidic acid, eleostearic acid, parinaric acid), saturated alcohols (e.g., stearyl alcohol, eicosyl alcohol, behenyl alcohol, carnaubyl alcohol, ceryl alcohol, melissyl alcohol, and other long-chain alkyl alcohol), polyols (e.g., sorbitol), fatty acid amides (e.g., linoleic acid amide, olefin acid amide, lauric acid amide), saturated fatty acid bisamides (e.g., methylenebis capric acid amide, ethylenebis lauric acid amide, hexamethylenebis capric acid amide), unsaturated fatty acid amides (e.g., ethylenebis oleic acid amide, hexamethylenebis oleic acid amide, N,N′-dioleyl adipic acid amide, N,N′-dioleyl sebacic acid amide), aromatic biamides (e.g., m-xylenebis stearic acid amide, N,N-distearyl isophthalic acid amide), metal salts of fatty acids (e.g., calcium stearate, calcium laurate, zinc stearate, magnesium stearate), aliphatic hydrocarbon waxes to which a vinyl monomer such as styrene and an acrylic acid is grafted, partial ester compounds between a fatty acid such as behenic acid monoglyceride and a polyol, and methyl ester compounds having a hydroxyl group obtained by hydrogenating plant fats.

In particular, the following compounds are preferably used: a polyolefin obtained by radical polymerizing an olefin under high pressure; a polyolefin obtained by purifying low-molecular-weight by-products of a polymerization reaction of a high-molecular-weight polyolefin; a polyolefin polymerized under low pressure in the presence of a Ziegler catalyst or a metallocene catalyst; a polyolefin polymerized using radiation, electromagnetic wave, or light; a low-molecular-weight polyolefin obtained by thermally decomposing a high-molecular-weight polyolefin; paraffin wax; microcrystalline wax; Fischer-Tropsch wax; synthesized hydrocarbon waxes obtained by synthol method, hydrocoal method, or Arge method; synthesized waxes including a compound having one carbon atom as a monomer unit; hydrocarbon waxes having a functional group such as hydroxyl group and carboxyl group; mixtures of a hydrocarbon wax and that having a functional group; and these waxes to which a vinyl monomer such as styrene, a maleate, an acrylate, a methacrylate, and a maleic anhydride is grafted.

In addition, these waxes subjected to a press sweating method, a solvent method, a recrystallization method, a vacuum distillation method, a supercritical gas extraction method, or a solution crystallization method, so as to much more narrow the molecular weight distribution thereof are preferably used. Further, low-molecular-weight solid fatty acids, low-molecular-weight solid alcohols, low-molecular-weight solid compounds, and other compounds from which impurities are removed are preferably used.

The wax preferably has a melting point of from 70 to 140° C., and more preferably from 70 to 120° C., so that the resultant toner has a good balance of toner blocking resistance and offset resistance. When the melting point is too small, toner blocking resistance deteriorates. When the melting point is too large, offset resistance deteriorates.

When two or more waxes are used in combination, functions of both plasticizing and releasing simultaneously appear.

As a wax having a function of plasticizing, for example, a wax having a low melting point, a wax having a branched structure, and a wax having a polar group can be used.

As a wax having a function of releasing, for example, a wax having a high melting point, a wax having a straight-chain structure, and a nonpolar wax having no functional group can be used. For example, a combination of two waxes having the difference in melting point of from 10 to 100° C., and a combination of a polyolefin and a grafted polyolefin are preferable.

When two waxes having a similar structure are used in combination, a wax having relatively lower melting point exerts a function of plasticizing and the other wax having a relatively higher lower melting point exerts a function of releasing. When the difference in melting point between the two waxes is from 10 to 100° C., these functions are efficiently separately expressed. When the difference is too small, these functions are not efficiently separately expressed. When the difference is too large, each of the functions is hardly enhanced by their interaction. It is preferable that one wax has a melting point of from 70 to 120° C., more preferably from 70 to 100° C.

As mentioned above, a wax having a branched structure, a wax having a polar group such as a functional group, and a wax modified with a component different from the main component of the wax relatively exerts a function of plasticizing. On the other hand, a wax having a straight-chain structure, a nonpolar wax having no functional group, and an unmodified wax relatively exerts a function of releasing. Specific preferred examples of combinations of waxes include, but are not limited to, a combination of a polyethylene homopolymer or copolymer including ethylene as a main component, and a polyolefin homopolymer or copolymer including an olefin other than ethylene as a main component; a combination of a polyolefin and a graft-modified polyolefin; a combination of a hydrocarbon wax and one member selected from an alcohol wax, a fatty acid wax, and an ester wax, and; a combination of a Fischer-Tropsch wax or a polyolefin wax, and a paraffin wax or a microcrystalline wax; a combination of a Fischer-Tropsch wax and a polyolefin wax; a combination of a paraffin wax and a microcrystalline wax; and a combination of a hydrocarbon wax and one member selected from a carnauba wax, a candelilla wax, a rice wax, and a montan wax.

The toner preferably has a maximum endothermic peak in a temperature range of from 70 to 110° C. of the endothermic curve measured by DSC (differential scanning calorimetry). In this case, the toner has a good balance of preservability and fixability.

The toner preferably includes the wax in an amount of from 0.2 to 20 parts by weight, more preferably from 0.5 to 10 parts by weight, based on 100 parts by weight of the binder resin.

In the present invention, the melting point of a wax is defined as a temperature in which the maximum endothermic peak is observed in an endothermic curve measured by DSC.

As a DSC measurement instrument, a high-precision inner-heat power-compensation differential scanning calorimeter is preferably used. The measurement is performed according to a method based on ASTM D3418-82. The endothermic curve is obtained by heating a sample at a temperature increasing rate of 10° C./min, after once heating and cooling the sample.

The toner of the present invention may include any known charge controlling agent together with the silicon-containing polymer, having charge controlling ability.

Colorless or whitish materials are preferably used for the charge controlling agent. Colored materials are not preferably used because the color tone of the resultant toner may be changed. Specific preferred examples of usable charge controlling agent include, but are not limited to, metal complex dyes, fluorine-modified quaternary ammonium salts, metal salts of salicylic acid, and metal salts of salicylic acid derivatives. Specific examples of the above-described metals include, but are not limited to, aluminum, zinc, titanium, strontium, boron, silicon, nickel, iron, chromium, and zirconium.

Specific examples of usable commercially available charge controlling agents include, but are not limited to, BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; LRA-901, and LR-147 (boron complex), which are manufactured by Japan Carlit Co., Ltd.; quinacridone, azo pigments, and polymers having a functional group such as a sulfonate group, a carboxyl group, a quaternary ammonium group, etc.

The content of the charge controlling agent is determined depending on the species of the binder resin used, and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large a charge quantity, and thereby the electrostatic force of a developing roller attracting the toner increases, resulting in deterioration of the fluidity of the toner and image density of the toner images.

The charge controlling agent and the release agent can be melt-kneaded with the master batch or the binder resin, or directly added to the organic solvent. In order not to clog discharge openings, the charge controlling agent is preferably finely dispersed in an organic solvent by a wet pulverizer such as a bead mill.

As the magnetic materials for use in the toner of the present invention, the following compounds can be used: (1) magnetic iron oxides (e.g., magnetite, maghemite, ferrite) and iron oxides including other metal oxides; (2) metals (e.g., iron, cobalt, nickel) and metal alloys of the above metals with aluminum, cobalt, copper, lead, magnesium, tin, zinc, antimony, beryllium, bismuth, cadmium, calcium, manganese, selenium, titanium, tungsten, vanadium, etc.; and (3) mixtures thereof.

Specific examples of the magnetic materials include, but are not limited to, Fe₃O₄, γ-Fe₂O₃, ZnFe₂O₄, Y₃Fe₅O₁₂, CdFe₂O₄, Gd₃Fe₅O₁₂, CuFe₂O₄, PbFe₁₂O, NiFe₂O₄, NdFe₂O, BaFe₁₂O₁₉, MgFe₂O₄, MnFe₂O₄, LaFeO₃, iron powder, cobalt powder, and nickel powder. These can be used alone or in combination. Among these, powders of Fe₃O₄ and γ-Fe₂O₃ are preferably used.

In addition, magnetic iron oxides (e.g., magnetite, maghemite, ferrite) containing a dissimilar element and mixtures thereof can also be used. Specific examples of the dissimilar elements include, but are not limited to, lithium, beryllium, boron, magnesium, aluminum, silicon, phosphorus, germanium, zirconium, tin, sulfur, calcium, scandium, titanium, vanadium, chromium, manganese, cobalt, nickel, copper, zinc, and gallium. Among these, magnesium, aluminum, silicon, phosphorus, and zirconium are preferably used. The dissimilar element may be incorporated into the crystal lattice of an iron oxide; the oxide thereof may be incorporated into an iron oxide; or the oxide or hydroxide thereof may be present at the surface of an iron oxide. However, it is preferable that the oxide of the dissimilar element is incorporated into an iron oxide.

The dissimilar element is incorporated into a magnetic iron oxide by mixing a salt of the dissimilar element and the magnetic iron oxide and controlling the pH. The dissimilar element is deposited out on the surface of a magnetic iron oxide by adding a salt of the dissimilar element and controlling the pH.

The toner preferably includes the magnetic material in an amount of from 10 to 200 parts by weight, and more preferably from 20 to 150 parts by weight, based on 100 parts by weight of the binder resin. The magnetic material preferably has a number average particle diameter of from 0.1 to 2 μm, and more preferably from 0.1 to 0.5 μm. The number average particle diameter can be determined from a magnified photographic image obtained by a transmission electron microscope using a digitizer.

The magnetic material preferably has a coercive force of from 20 to 150 oersted, a saturation magnetization of from 50 to 200 emu/g, and a residual magnetization of from 2 to 20 emu/g, when 10K oersted of magnetic field is applied.

The magnetic material can also be used as a colorant.

The binder resin preferably has a glass transition temperature (Tg) of from 30 to 120° C., and more preferably from 40 to 70° C. When the Tg is too small, preservability of the toner deteriorates. When the Tg is too large, low-temperature fixability of the toner deteriorates.

The glass transition temperature (Tg) can be measured using differential scanning calorimeter DSC-60 equipped with a thermal analysis work station TA-60WS (from Shimadzu Corporation) under the following conditions, for example.

Sample container: Aluminum sample pan with a lid

Sample quantity: 5 mg

Reference: Aluminum sample pan containing 10 mg of aluminum

Atmosphere: Nitrogen (flow rate: 50 ml/min)

Temperature conditions:
Start temperature: 20° C.
Temperature rising rate: 10° C./min
End temperature: 150° C.
Retention time: none
Temperature decreasing rate: 10° C./min
End temperature: 20° C.
Retention time: none
Temperature rising rate: 10° C./min
End temperature: 150° C.

Measurement results are analyzed using data analysis software TA-60 version 1.52 (from Shimadzu Corporation). A DrDSC curve, which is a differential curve of a DSC curve obtained in the second temperature rising scan, is analyzed using a peak analysis function of the software. A temperature where a shoulder of a peak, which represents the first glass-transition of a sample, is observed is defined as the glass transition temperature.

The toner of the present invention may include an external additive such as a fluidity improving agent and a cleanability improving agent. The fluidity improving agent enables the resultant toner to easily fluidize by being added to the surface of the toner.

Specific examples of the fluidity improving agents include, but are not limited to, fine powders of fluorocarbon resins such as vinylidene fluoride and polytetrafluoroethylene; fine powders of silica prepared by a wet process or a dry process, titanium oxide, and alumina; and these silica, titanium oxide, and alumina surface-treated with a silane-coupling agent, a titanium-coupling agent, or a silicone oil. Among these, fine powders of silica, titanium oxide, and alumina are preferably used, and the silica surface-treated with a silane-coupling agent or a silicone oil is more preferably used.

The fluidity improving agent preferably has an average primary particle diameter of from 5 to 500 nm, and more preferably from 7 to 120 nm.

A fine powder of silica is prepared by a vapor phase oxidization of a halogenated silicon compound, and typically called a dry process silica or a fumed silica.

Specific examples of useable commercially available fine powders of silica prepared by a vapor phase oxidation of a halogenated silicon compound include, but are not limited to, AEROSIL® 130, 300, 380, TT600, MOX170, MOX80, and COK84 (from Nippon Aerosil Co., Ltd.), CAB-O-SIL® M-5, MS-7, MS-75, HS-5, and EH-5 (from Cabot Corporation), WACKER HDK® N20, V15, N20E, T30, and T40 (from Wacker Chemie Gmbh), Dow Corning® Fine Silica (from Dow Coming Corporation), and FRANSIL (from Fransol Co.).

A hydrophobized fine powder of silica prepared by a vapor phase oxidation of a halogenated silicon compound is more preferably used. The hydrophobized silica preferably has a hydrophobized degree of from 30 to 80%, measured by a methanol titration test. The hydrophobic property is imparted to a silica when an organic silicon compound is reacted with or physically adhered to the silica. A hydrophobizing method in which a fine powder of silica prepared by a vapor phase oxidation of a halogenated silicon compound is treated with an organic silicon compound is preferable.

Specific examples of the organic silicon compounds include, but are not limited to, hydroxypropyltrimethoxysilane, phenyltrimethoxysilane, n-hexadecyltrimethoxysilane, n-octadecyltrimethoxysilane, vinyltrimethoxysilane, vinyltriethoxysilane, vinyltriacetoxysilane, dimethylvinylchlorosilane, divinylchlorosilane, γ-methacryloxypropyltrimethoxysilane, hexamethyldisilazane, trimethylsilane, trimethylchlorosilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, triorganosilyl acrylate, vinyldimethylacetoxysilane, dimethylethoxysilane, trimethylethoxysilane, trimethylmethoxysilane, methyltriethoxysilane, isobutyltrimethoxysilane, dimethyldimethoxysilane, diphenyldiethoxysilane, hexamethyldisiloxane, 1,3-divinyltetramethyldisiloxane, 1,3-diphenyltetramethyldisiloxane, dimethylpolysiloxane having 2 to 12 siloxane units per molecule and 0 to 1 hydroxyl group bound to Si in the end siloxane units, and silicone oils such as dimethyl silicone oil. These can be used alone or in combination.

The fluidity improving agent preferably has a number average particle diameter of from 5 to 100 nm, and more preferably from 5 to 50 nm.

The fluidity improving agent preferably has a specific surface area of not less than 30 m²/g, and more preferably from 60 to 400 m²/g, measured by nitrogen adsorption BET method. The surface-treated fluidity improving agent preferably has a specific surface area of not less than 20 m²/g, and more preferably from 40 to 300 m²/g, measured by nitrogen adsorption BET method. The toner preferably includes the fluidity improving agent in an amount of from 0.03 to 8 parts by weight based on 100 parts by weight of the toner.

A cleanability improving agent is added to the toner so that toner particles remaining on the surface of a photoreceptor or a primary transfer medium after a toner image is transferred onto a recording paper, etc. are efficiently removed. Specific examples of the cleanability improving agents include, but are not limited to, metal salts of fatty acids such as zinc stearate and calcium stearate; fine particles of polymers such as polymethyl methacrylate and polystyrene, which are manufactured by a method such as soap-free emulsion polymerization methods; and fine particles of silicone, benzoguanamine, and nylon. Fine polymer particles having a relatively narrow particle diameter distribution and a volume average particle diameter of from 0.01 μm to 1 μm are preferably used as the cleanability improving agent.

The toner of the present invention may optionally include other external additives such as a metallic soap, a fluorochemical surfactant, dioctyl phthalate, a conductivity imparting agent such as tin oxide, zinc oxide, carbon black, and antimony oxide, and a fine powder of an inorganic material such as titanium oxide, aluminum oxide, and alumina, for the purpose of protecting an image bearing member and a carrier, controlling thermal, electric, and physical properties such as resistivity, and softening point, improving fixability, etc. The inorganic material may be hydrophobized, if desired. The toner may further include a lubricant such as polytetrafluoroethylene, zinc stearate, and polyvinylidene fluoride, an abrasive such as cesium oxide, silicon carbide, and strontium titanate, a caking preventing agent, and a developability improving agent such as white or black fine powders having a reverse polarity to the toner.

The above-described external additives may be treated with a treatment agent such as a silicone varnish, a modified silicone varnish, a silicone oil, a modified silicone oil, a silane coupling agent, a silane coupling agent having a functional group, and an organic silicon compound, for the purpose of controlling charge quantity thereof.

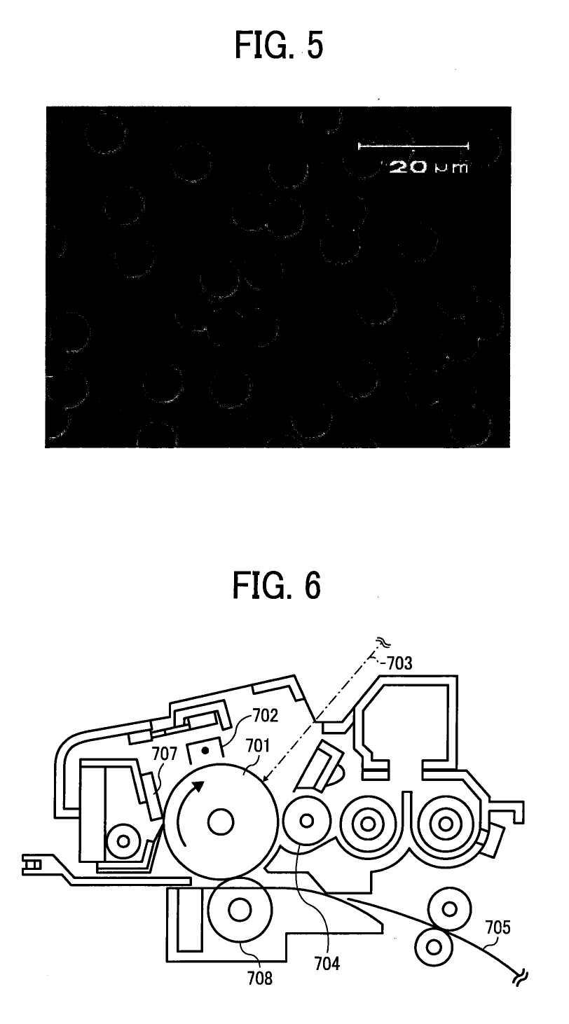

The toner of the present invention may have any shape and size. FIG. 5 is an example of a SEM (scanning electron microscope) image of the toner of the present invention (prepared in Example 8 to be described later). Preferable average circularity and average particle diameter will be described.

The circularity of a particle is determined by the following equation:

Circularity=Cs/Cp

wherein Cp represents the length of the circumference of a projected image of a particle and Cs represents the length of the circumference of a circle (hereinafter referred to as the “equivalent circle”) having the same area as that of the projected image of the particle. (The particle diameter of the equivalent circle is hereinafter referred to as the “circle-equivalent particle diameter”.) The toner of the present invention preferably has an average circularity of from 0.900 to 0.980, and more preferably from 0.950 to 0.975. Further, the toner preferably includes toner particles having a circularity of less than 0.94 in an amount of not greater than 15%.

When the average circularity is too small, the toner has poor transferability, resulting in occurrence of toner scattering in the resultant image. When the average circularity is too large, the toner has poor cleanability particularly in an image forming system employing a cleaning blade, resulting in occurrence of background fouling in the resultant image due to contamination of residual toner particles to a photoreceptor or a transfer belt. Furthermore, a charging roller may also be contaminated with residual toner particles.

The average circularity of a toner can be determined using a flow-type particle image analyzer FPIA-2000 manufactured by Sysmex Corp., for example.

The typical measurement method is as follows:
(1) water is filtered to remove undesired substances therefrom so that not greater than 20 particles of the undesired substances having a measurable circle-equivalent particle diameter (not less than 0.60 μm and less than 159.21 μm, for example) are contained per 10⁻³ cm³ of the water;
(2) a few drops of a nonionic surfactant (such as CONTAMINON® N from Wako Pure Chemical Industries, Ltd.) is added to 10 ml of the filtered water;
(3) 5 mg of a sample is added to the filtered water to prepare a sample dispersion, and dispersed for 1 minute using an ultrasonic disperser (UH-5 from SMT Co., Ltd.) at 20 kHz and 50 W/10 cm³;
(4) the sample is further dispersed for 5 minutes; and
(5) the sample dispersion containing 4,000 to 8,000 particles, having the measurable circle-equivalent particle diameter, per 10⁻³ cm³ thereof is subjected to a measurement of the circle-equivalent particle diameter distribution within a circle-equivalent particle diameter range of not less than 0.60 μm and less than 159.21 μm.

The sample dispersion is passed through a flow path of a flat transparent flow cell having a thickness of about 200 μm. A stroboscopic lamp and a CCD camera are laterally provided each other across the flow cell so that an optical path is formed intersecting the flow cell in the thickness direction. The flowing sample dispersion is irradiated with a stroboscopic light at an interval of 1/30 second so that a two dimensional image of flowing particles, which is parallel to the flow cell and having the same area thereof, is obtained. The circle-equivalent particle diameter of a particle is defined as the diameter of a circle having the same area as that of the two dimensional image (i.e., projected image) of the particle.

The circle-equivalent particle diameters of more than 1,200 particles can be measured within about 1 minute, and thereby the circle-equivalent particle diameter distribution can be obtained. The number and the ratio (% by number) of particles having a specific circle-equivalent particle diameter can be determined from the circle-equivalent particle diameter distribution. The circle-equivalent particle diameter distribution (in % by frequency and % by cumulative frequency) is obtained by dividing a circle-equivalent particle diameter range of from 0.06 to 400 μm into 226 channels (i.e., 1 octave is divided into 30 channels). In particular, the measurement is performed within a circle-equivalent particle diameter range of not less than 0.60 μm and less than 159.21 μm.

The weight average particle diameter and the particle diameter distribution of a toner can be measured using an instrument such as COULTER COUNTER TA-II and COULTER MULTISIZER II (both from Beckman Coulter K. K.), for example.

The typical measuring method is as follows:
(1) 0.1 to 5 ml of a surfactant (preferably an alkylbenzene sulfonate) is included as a dispersant in 100 to 150 ml of an electrolyte (i.e., 1% NaCl aqueous solution including a first grade sodium chloride such as ISOTON-II from Coulter Electrons Inc.);
(2) 2 to 20 mg of a toner is added to the electrolyte and dispersed using an ultrasonic dispersing machine for about 1 to 3 minutes to prepare a toner suspension liquid;
(3) the weight and number of toner particles in the toner suspension liquid are measured by the above instrument using an aperture of 100 μm to determine the weight and number distribution thereof; and
(4) the weight average particle diameter (D4) and the number average particle diameter (Dn) are determined from the weight and number distributions, respectively.

The channels include 13 channels as follows: from 2.00 to less than 2.52 μm; from 2.52 to less than 3.17 μm; from 3.17 to less than 4.00 μm; from 4.00 to less than 5.04 μm; from 5.04 to less than 6.35 μm; from 6.35 to less than 8.00 μm; from 8.00 to less than 10.08 μm; from 10.08 to less than 12.70 μm; from 12.70 to less than 16.00 μm; from 16.00 to less than 20.20 μm; from 20.20 to less than 25.40 μm; from 25.40 to less than 32.00 μm; and from 32.00 to less than 40.30 μm. Namely, particles having a particle diameter of from not less than 2.00 μm to less than 40.30 μm can be measured.

The toner of the present invention preferably has a weight average particle diameter of from 1 to 10 μm, and more preferably from 3 to 8 μm.

When the weight average particle diameter is too small, the toner tends to fuse on the surface of a carrier by long-term agitation in a developing device, resulting in deterioration of chargeability of the carrier, when the toner is used for a two-component developer. When the toner is used for a one-component developer, problems such that the toner forms a film on a developing roller, and the toner fuses on a toner layer forming member tend to be caused. In contrast, when the weight average particle diameter is too large, it is difficult to obtain high definition and high quality images. In addition, the average particle diameter of a toner included in a developer tends to largely vary when a part of toner particles are replaced with fresh toner particles.

The ratio of the weight average particle diameter to the number average particle diameter is preferably from 1.00 to 1.10, and more preferably from 1.00 to 1.05.

When the ratio is too large, the toner tends to fuse on the surface of a carrier by long-term agitation in a developing device, resulting in deterioration of chargeability of the carrier, when the toner is used for a two-component developer. When the toner is used for a one-component developer, problems such that the toner forms a film on a developing roller, and the toner fuses on a toner layer forming member tend to be caused. Furthermore, it is difficult to obtain high definition and high quality images. Moreover, the average particle diameter of a toner included in a developer tends to largely vary when a part of the toner particles are replaced with fresh toner particles.

Particularly, when the toner includes a small amount of fluidity improving agent, fluidity of the toner may deteriorate resulting in deterioration of toner supplying efficiency from a toner container to a developing part.

### (Developer)

The developer of the present invention includes the toner of the present invention and other components such as a carrier. The developer may be both a one-component developer and a two-component developer. In particular, high-speed printers preferably use a two-component developer in terms of life.

When the toner of the present invention is used for a one-component developer, the average particle diameter of a toner included in a developer may not largely vary even if a part of the toner particles are replaced with fresh toner particles. Moreover, problems such that the toner forms a film on a developing roller, and the toner fuses on a toner layer forming member are hardly caused. Therefore, high definition and high quality images can be produced. When the toner of the present invention is used for a two-component developer, the average particle diameter of a toner included in a developer may not largely vary even if a part of the toner particles are replaced with fresh toner particles. Furthermore, the developer has stable developability even under long-term agitation in a developing device.

Specific preferred examples of suitable carriers used for the two-component developer includes typical ferrite carriers and magnetite carriers, and a carrier covered with a resin layer (hereinafter referred to as a “resin-covered carrier”).

The resin-covered carrier comprises a core particle and a covering material (i.e., resin) which covers the surface of the core.

Specific examples of materials used for the core particle include, but are not limited to, manganese-strontium (Mn—Sr) and manganese-magnesium (Mn—Mg) materials having a magnetization of from 50 to 90 emu/g. In terms of obtaining high image density, high-magnetization materials such as iron powders (not less than 100 emu/g) and magnetites (75 to 120 emu/g) are preferably used. Low-magnetization materials such as copper-zinc (Cu—Zn) materials (30 to 80 emu/g) are preferably used because a magnetic brush of a developer using such a material can softly contact a photoreceptor, resulting in production of high quality image. These materials can be used alone or in combination.

The core particle preferably has a volume average particle diameter of from 10 to 150 μm, and more preferably from 40 to 100 μm.

When the volume average particle diameter is too small, the carrier includes too large an amount of ultrafine particles, and therefore the magnetization per one particle decreases. As a result, carrier scattering is caused. When the volume average particle diameter is too large, the specific area decreases, resulting in occurrence of toner scattering. Particularly in a full-color image, reproducibility of solid image portions may deteriorate.

Specific examples of the covering materials include, but are not limited to, amino resins, polyvinyl resins, polystyrene resins, halogenated olefin resins, polyester resins, polycarbonate resins, polyethylene resins, polyvinylidene fluoride resins, polytrifluoroethylene resins, polyhexafluoropropylene resins, copolymers of vinylidene fluoride and an acrylic monomer, copolymers of vinylidene fluoride and vinyl fluoride, terpolymers of tetrafluoroethylene, vinylidene fluoride, and a non-fluorinated monomer, and silicone resins. These can be used alone or in combination.

Specific examples of the amino resins include, but are not limited to, urea-formaldehyde resins, melamine resins, benzoguanamine resins, urea resins, polyamide resins, and epoxy reins. Specific examples of the polyvinyl resins include, but are not limited to, acrylic resins, polymethyl methacrylate resins, polyacrylonitrile resins, polyvinyl acetate resins, polyvinyl alcohol resins, and polyvinyl butyral resins. Specific examples of the polystyrene resins include, but are not limited to, polystyrene resins and styrene-acrylic copolymers. Specific examples of the halogenated olefin resins include, but are not limited to, polyvinyl chloride. Specific examples of the polyester resins include, but are not limited to, polyethylene terephthalate resins and polybutylene terephthalate resins.

The resin layer may include a conductive powder, if desired. Specific examples of the conductive powder include, but are not limited to, metal powders, carbon black, titanium oxide, tin oxide, and zinc oxide. The conductive powder preferably has an average particle diameter of not greater than 1 μm. When the average particle diameter is too large, it is difficult to control electric resistance of the carrier.

The resin layer can be formed by, for example, dissolving a silicone resin, etc., in a solvent to prepare a coating liquid, applying the coating liquid to the surface of the core by known methods such as a dip coating method and a spray coating method, and subsequently drying and baking the applied coating liquid.

Specific examples of the solvents for preparing the coating liquid include, but are not limited to, toluene, xylene, methyl ethyl ketone, methyl isobutyl ketone, and cellosolve butyl acetate.

The baking method can be either or both of an external heating method or an internal heating method. Specific baking methods include, but are not limited to, methods using a fixed electric furnace, a portable electric furnace, a rotary electric furnace, a burner furnace, and a microwave.

The carrier preferably includes the resin layer in an amount of from 0.01 to 5.0% by weight. When the amount is too small, a uniform resin layer may not be formed on the surface of the core particle. When the amount is too large, the resin layer has too large a thickness, carrier particles adhere with each other, and therefore uniform carrier particles may not be obtained.

The two-component developer preferably includes a carrier in an amount of from 90 to 98% by weight, and more preferably from 93 to 97% by weight.

Since the developer of the present invention includes the toner of the present invention, the developer has good chargeability and high quality images are stably produced.

### (Toner Container)

The toner and developer of the present invention may be contained in a toner container. Suitable toner containers include any known containers including a main body of a toner container and a cap.

The toner container is not limited in size, shape, structure, material, etc. The toner container preferably has a cylindrical shape having spiral projections and depressions on the inner surface thereof. Such a toner container can feed a toner to an ejection opening by rotating. It is more preferable that a part of the spiral parts, or all of the spiral parts of such a toner container have a structure like an accordion.

Suitable materials for use in the toner container include materials having good dimensional accuracy. In particular, resins are preferably used. Specific examples of the resins for use in the toner container include, but are not limited to, polyester resins, polyethylene resins, polypropylene resins, polystyrene resins, polyvinylchloride resins, polyacrylic acids, polycarbonate resins, ABS resins, and polyacetal resins.

The toner container can be easily preserved, transported, handled, and detached from a process cartridge and an image forming apparatus to feed a toner thereto.

### (Process Cartridge)

The process cartridge of the present invention includes an electrostatic latent image bearing member to bear an electrostatic latent image and a developing device to develop the electrostatic latent image with a developer to form a toner image, and may optionally include other members, if desired.

The developing device includes a developer container to contain the toner or developer of the present invention and a developer bearing member to bear and transport the toner or developer, and may optionally include a layer thickness controlling member to control the thickness of the toner borne by the developer bearing member.

FIG. 6 is a schematic view illustrating an embodiment of the process cartridge of the present invention.

A process cartridge illustrated in FIG. 6 includes a photoreceptor 701, a charger 702, a developing device 704, a transfer device 708, and a cleaning device 707. In FIG. 6, a reference number 703 represents a light beam emitted by a light irradiator (not shown) and a reference number 705 represents a recording medium.

Next, an image forming process of the process cartridge illustrated in FIG. 6 will be explained.

The photoreceptor 701 is charged by the charger 702, and subsequently irradiated with the light beam 703 emitted by the light irradiator (not shown) while rotating in the direction indicated by an arrow so that an electrostatic latent image is formed thereon. The electrostatic latent image is developed by the developing device 704 to form a toner image, and subsequently the toner image is transferred onto the recording medium 705 by the transfer device 708. The surface of the photoreceptor 701 is cleaned with the cleaning device 707 after the toner image is transferred, and subsequently discharged by a discharging device (not shown). This image forming operation is repeatedly performed.

### (Image Forming Apparatus)

The image forming apparatus of the present invention includes an electrostatic latent image bearing member, an electrostatic latent image forming device, a developing device, a transfer device, and a fixing device, and optionally includes a discharge device, a cleaning device, a recycle device, a control device, and the like, if desired.

The image forming apparatus of the present invention forms an image by an image forming method including an electrostatic latent image forming process, a developing process, a transfer process, and a fixing process, and optionally including a discharge process, a cleaning process, a recycle process, a control process, and the like, if desired.

In the electrostatic latent image forming process, an electrostatic latent image is formed on an electrostatic latent image bearing member.

The material, shape, structure, and size of the electrostatic latent image bearing member (hereinafter referred to as photoreceptor, photoconductor, image bearing member, etc.) are not particularly limited. A drum-like shaped image bearing member is preferably used. As for the material, inorganic photoreceptors including an amorphous silicon, selenium, etc., and organic photoreceptors can be use as the image bearing member.

The electrostatic latent image forming device forms an electrostatic latent image by uniformly charging the surface of the electrostatic latent image bearing member, and subsequently irradiating the charged surface of the electrostatic latent image bearing member with a light beam containing image information, for example.

The electrostatic latent image forming device includes a charger to uniformly charge the surface of the electrostatic latent image bearing member and an irradiator to irradiate the charged surface of the electrostatic latent image bearing member with a light beam containing image information, for example.

In the charging process, the charger applies a voltage to the surface of the electrostatic latent image bearing member.

As the charger, for example, any known contact chargers such as a conductive or semi-conductive roller, brush, film, and rubber blade, and any known non-contact chargers such as corotron and scorotron using corona discharge can be used.

In the irradiating process, the charged surface of the electrostatic latent image bearing member is irradiated with a light beam containing image information by the irradiator.

Any known irradiators capable of irradiating the charged surface of the electrostatic latent image bearing member can be used, so that a latent image is formed thereon. For example, irradiators using a radiation optical system, a rod lens array, a laser optical system, a liquid crystal shutter optical system, an LED optical system, etc., can be used.

In the present invention, the electrostatic latent image bearing member may be irradiated with a light beam containing image information from the backside thereof.

In the developing process, the electrostatic latent image is developed with the toner or developer of the present invention to form a toner image.

The developing device forms the toner image by developing the electrostatic latent image with the toner or developer of the present invention.

Any known developing devices capable of developing the electrostatic latent image with the toner or developer of the present invention can be used. For example, a developing device containing the toner or developer of the present invention, preferably contained in the above-described toner container, and capable of supplying the toner or developer to the electrostatic latent image by either being in or out of contact therewith can be used.

The developing device may be either a single-color or a multi-color developing device. The developing device includes an agitator to agitate the toner or developer so as to be triboelectrically charged and a rotatable magnetic roller, for example.

In the developing device, the toner and the carrier are mixed so that the toner is charged. The developer (i.e., the toner and the carrier) forms magnet brushes on the surface of the rotatable magnetic roller. Since the magnetic roller is provided adjacent to the electrostatic latent image bearing member, a part of the toner that forms the magnetic brushes on the magnetic roller is moved to the surface of the electrostatic latent image bearing member due to an electric attraction force. As a result, the electrostatic latent image is developed with the toner and a toner image is formed on the surface of the electrostatic latent image bearing member.

The developer may be either a one-component developer or a two-component developer. The developer includes the toner of the present invention.

In the transfer process, a toner image is transferred onto a recording medium. It is preferable that the toner image is firstly transferred onto an intermediate transfer member, and subsequently transferred onto the recording medium. It is more preferable that the transfer process includes a primary transfer process in which two or more monochrome toner images, preferably in full color, are transferred onto the intermediate transfer member to form a composite toner image and a secondary transfer process in which the composite toner image is transferred onto the recording medium.

The transfer process is performed by, for example, charging a toner image formed on the electrostatic latent image bearing member by the transfer device such as a transfer charger. The transfer device preferably includes a primary transfer device to transfer monochrome toner images onto an intermediate transfer member to form a composite toner image and a secondary transfer device to transfer the composite toner image onto a recording medium.

Any known transfer members can be used as the intermediate transfer member. For example, a transfer belt is preferably used.

The transfer device (such as the primary transfer device and the secondary transfer device) preferably includes a transferrer to separate the toner image from the electrostatic latent image bearing member to the recording medium. The transfer device may be used alone or in combination.

As the transferrer, a corona transferrer using corona discharge, a transfer belt, a transfer roller, a pressing transfer roller, an adhesion transferrer, etc., can be used.

As the recording medium, any known recording media (such as a recording paper) can be used.

In the fixing process, the toner image transferred onto a recording medium is fixed thereon by the fixing device. Each of monochrome toner images may be independently fixed on the recording medium. Alternatively, a composite toner image in which monochrome toner images are superimposed may be fixed at once.

As the fixing device, any known heat and pressure applying devices are preferably used. As the heat and pressure applying device, a combination of a heat applying roller and a pressure applying roller, a combination of a heat applying roller, a pressure applying roller, and a seamless belt, etc., can be used.

The heat and pressure applying device preferably heats an object to a temperature of from 120 to 200° C.

Any known optical fixing devices may be used alone or in combination with the above-mentioned fixing device in the fixing process of the present invention.

In the discharge process, charges remaining on the electrostatic latent image bearing member are removed by applying a discharge bias to the electrostatic latent image bearing member. The discharge process is preferably performed by a discharge device.

As the discharge device, any known dischargers capable of applying a discharge bias to the electrostatic latent image bearing member can be used. For example, a discharge lamp is preferably used.

In the cleaning process, toner particles remaining on the electrostatic latent image bearing member are removed by a cleaning device.

As the cleaning device, any known cleaners capable of removing toner particles remaining on the electrostatic latent image bearing member can be used. For example, a magnetic brush cleaner, an electrostatic brush cleaner, a magnetic roller cleaner, a blade cleaner, a brush cleaner, a web cleaner, etc. can be used.

In the recycle process, the toner particles removed in the cleaning process are recycled by a recycle device.

As the recycle device, any known feeding devices can be used, for example.

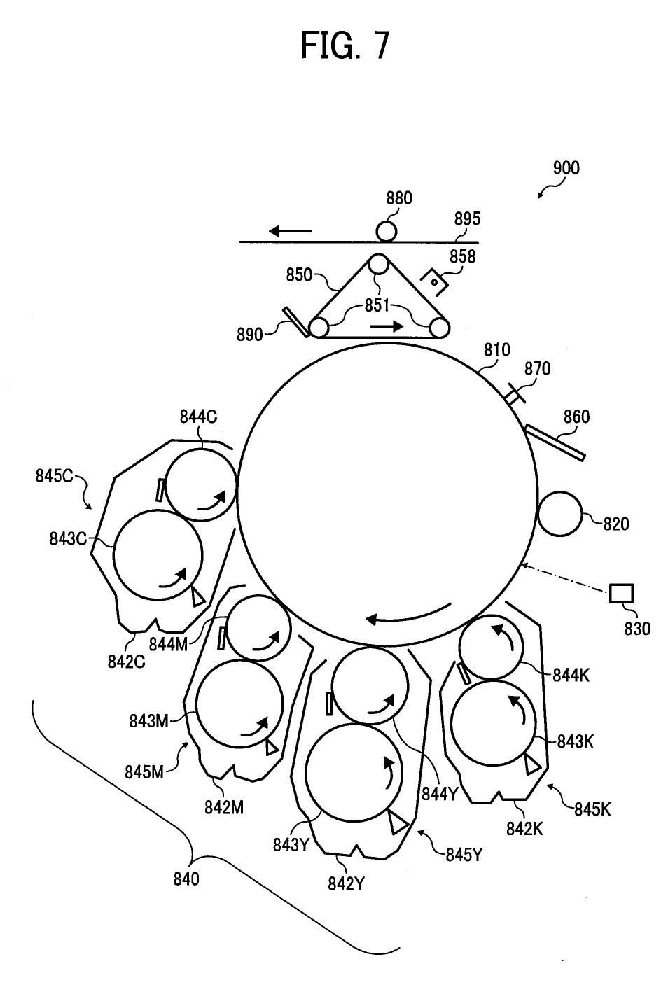

FIG. 7 is a schematic view illustrating an embodiment of the image forming apparatus of the present invention.

An image forming apparatus 900 includes a photoreceptor 810 serving as the electrostatic latent image bearing member, a charging roller 820 serving as the charger, a light irradiator 830 serving as the irradiator, a developing device 840 serving as the developing device, an intermediate transfer medium 850, a cleaning device 860 including a cleaning blade serving as the cleaning device, and a discharging lamp 870 serving as the discharging device.

The developing device 840 includes a black developing unit 845K, a yellow developing unit 845Y, a magenta developing unit 845M, and a cyan developing unit 845C, provided around the photoreceptor 10. The developing units 845K, 845Y, 845M, and 845C include developer containers 842K, 842Y, 842M, and 842C, developer feeding rollers 843K, 843Y, 843M, and 843C, and developing rollers 844K, 844Y, 844M, and 844C, respectively.

The intermediate transfer medium 850 is an endless belt. The intermediate transfer medium 850 is tightly stretched with three rollers 851 to move endlessly in a direction indicated by an arrow. Some of the rollers 851 have a function of applying a transfer bias (i.e., primary transfer bias) to the intermediate transfer medium 850. A cleaning device 890 including a cleaning blade is provided close to the intermediate transfer medium 850. A transfer roller 880 serving as the transfer device is provided facing the intermediate transfer medium 850. The transfer roller 880 is capable of applying a transfer bias to transfer (i.e., secondary transfer) a toner image onto a transfer paper 895. A corona charger 858 configured to charge the toner image on the intermediate transfer medium 850 is provided on a downstream side from a contact point of the photoreceptor 810 and the intermediate transfer medium 850, and a upstream side from a contact point of the intermediate transfer medium 850 and the transfer paper 895, relative to the rotating direction of the intermediate transfer medium 850.

In the image forming apparatus 900, the photoreceptor 810 is uniformly charged by the charging roller 820, and subsequently the light irradiator 830 irradiates the photoreceptor 810 with a light containing image information to form an electrostatic latent image thereon. The electrostatic latent image formed on the photoreceptor 810 is developed with a toner supplied from the developing device 840, to form a toner image. The toner image is transferred onto the intermediate transfer medium 850 due to a bias applied to some of the rollers 851 (i.e., primary transfer), and subsequently transferred onto the transfer paper 895 (i.e., secondary transfer). Toner particles remaining on the photoreceptor 810 are removed by the cleaning device 860, and the photoreceptor 810 is once discharged by the discharging lamp 870.

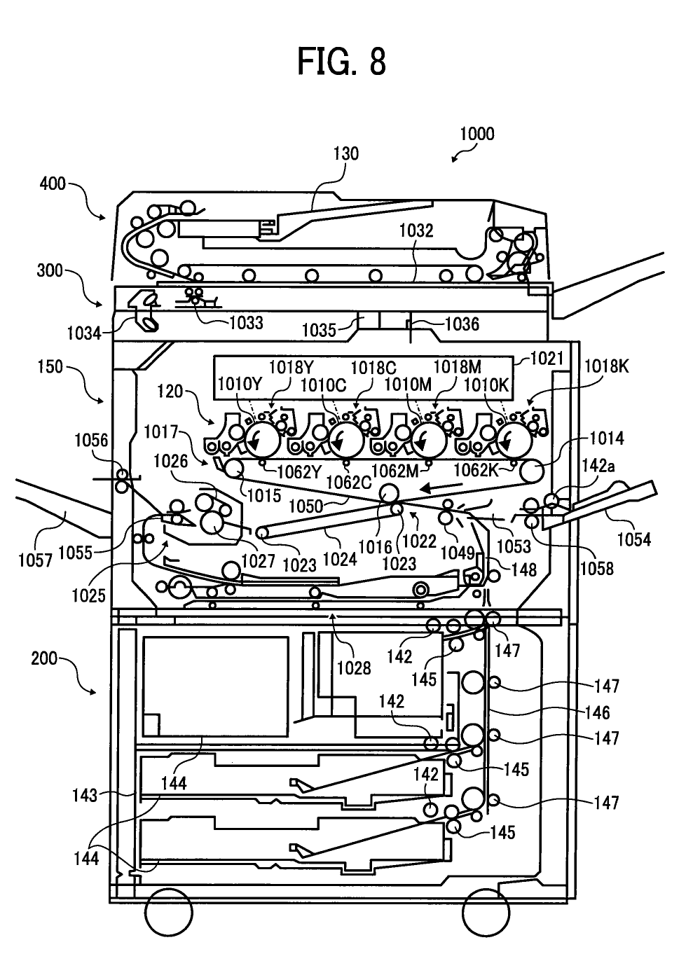

FIG. 8 is a schematic view illustrating another embodiment of the image forming apparatus of the present invention. The image forming apparatus 1000 is a tandem color image forming apparatus. The image forming apparatus 1000 includes a main body 150, a paper feeding table 200, a scanner 300, and an automatic document feeder (ADF) 400.

An intermediate transfer medium 1050 is provided in the center of the main body 150. The intermediate transfer medium 1050, which is an endless belt, is tightly stretched with support rollers 1014, 1015 and 1016 to rotate in a clockwise direction. A cleaning device 1017, configured to remove residual toner particles remaining on the intermediate transfer medium 1050, is provided close to the support roller 1015. A tandem-type image forming device 120 including image forming units 1018Y, 1018C, 1018M and 1018K is provided facing the intermediate transfer medium 1050 so that the image forming units 1018Y, 1018C, 1018M and 1018K are arranged in this order around the intermediate transfer medium 1050 relative to the rotating direction thereof.

A light irradiator 1021 is provided close to the tandem-type image forming device 120. A secondary transfer device 1022 is provided on the opposite side of the intermediate transfer medium 1050 relative to the tandem-type image forming device 120. The secondary transfer device 1022 includes a secondary transfer belt 1024, which is an endless belt, tightly stretched with a pair of rollers 1023. A transfer paper transported on the secondary transfer belt 1024 can contact the intermediate transfer medium 1050. A fixing device 1025 is provided close to the secondary transfer device 1022. The fixing device 1025 includes a fixing belt 1026, which is an endless belt, and a pressing roller 1027 configured to press the fixing belt 1026.

A reversing device 1028 configured to reverse a transfer paper to form images on both sides of the transfer paper is provided close to the secondary transfer device 1022 and the fixing device 1025.

Next, a procedure of forming a full color image with the image forming apparatus 1000 will be explained. An original document is set to a document feeder 130 included in the automatic document feeder (ADF) 400, or placed on a contact glass 1032 included in the scanner 300 by lifting up the automatic document feeder 400.

When a start switch button (not shown) is pushed, the scanner 300 starts driving and a first runner 1033 and a second runner 1034 start moving. When the original document is set to the document feeder 130, the scanner 300 starts driving after the original document is fed on the contact glass 1032. When the original document is placed on the contact glass 1032, the scanner 300 starts driving immediately after the start switch button is pushed. The original document is irradiated with a light emitted by a light source via the first runner 1033, and the light reflected from the original document is then reflected by a mirror included in the second runner 1034. The light passes through an imaging lens 1035 and is received by a reading sensor 1036. Thus, image information of each color is read.

Each color image information is transmitted to the image forming units 1018Y, 1018C, 1018M and 1018K, respectively, to form each color toner image.

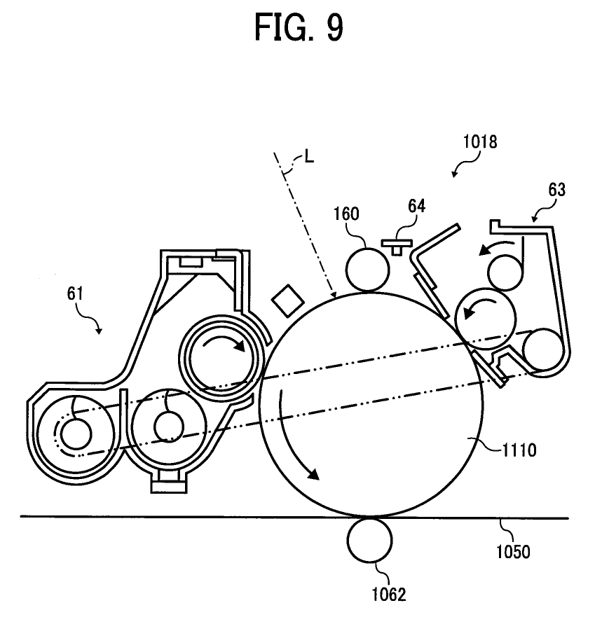

FIG. 9 is a schematic view illustrating an embodiment of the image forming units 1018Y, 1018C, 1018M and 1018K. Since the image forming units 1018Y, 1018C, 1018M and 1018K have the same configuration, only one image forming unit is illustrated in FIG. 9. Symbols Y, C, M and K, which represent each of the colors, are omitted from the reference number.

The image forming unit 1018 includes a photoreceptor 1110, a charger 160 configured to uniformly charge the photoreceptor 1110, a light irradiator (not shown) configured to irradiate a light L containing image information corresponding to color information to form an electrostatic latent image on the photoreceptor 1110, a developing device 61 configured to develop the electrostatic latent image with a toner to form a toner image, a transfer charger 1062 configured to transfer the toner image onto the intermediate transfer medium 1050, a cleaning device 63, and a discharging device 64.

Black, yellow, magenta, and cyan toner images formed on black, yellow, magenta, and cyan photoreceptors 1010K, 1010Y, 1010M, 1010C, respectively, are independently transferred (i.e., primary transfer) onto the intermediate transfer medium 1050 and superimposed thereon so that a full-color toner image is formed.

On the other hand, referring back to FIG. 8, in the paper feeding table 200, a recording paper is fed from one of multistage paper feeding cassettes 144, included in a paper bank 143, by rotating one of paper feeding rollers 142. The recording paper is separated by separation rollers 145 and fed to a paper feeding path 146. The recording paper is transported to a paper feeding path 148, included in the main body 150, by transport rollers 147, and is stopped by a registration roller 1049. When the recording paper is fed from a manual paper feeder 1054 by rotating a paper feeding roller 142a, the recording paper is separated by a separation roller 1058 to be fed to a manual paper feeding path 1053, and is stopped by the registration roller 1049. The registration roller 1049 is typically grounded, however, a bias can be applied thereto in order to remove paper powder.

The recording paper is timely fed to an area formed between the intermediate transfer medium 1050 and the secondary transfer device 1022, by rotating the registration roller 1049, to meet the full-color toner image formed on the intermediate transfer medium 1050. The full-color toner image is transferred onto the recording material in the secondary transfer device 1022 (secondary transfer). Toner particles remaining on the intermediate transfer medium 1050 are removed with the cleaning device 1017.

The recording paper having the toner image thereon is transported from the secondary transfer device 1022 to the fixing device 1025. The toner image is fixed on the recording paper by application of heat and pressure thereto in the fixing device 1025. The recording paper is switched by a switch pick 1055, ejected by an ejection roller 1056, and stacked on an ejection tray 1057. When the recording paper is switched by the switch pick 1055 to be reversed in the reverse device 1028, the recording paper is fed to a transfer area again in order to form a toner image on the backside thereof. The recording paper having a toner image on the back side thereof is ejected by the ejection roller 1056 and stacked on the ejection tray 1057.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Synthesis Example 1

### (Synthesis of Silicon-Containing Polymer (1))

In a 5 L four-neck separable flask equipped with a stirrer and a condenser tube, 120 g of methyl ethyl ketone and 45 g of a silicon-containing radical-polymerizable monomer (SILAPLANE FM-0711 from Chisso Corporation) are contained and heated to 80° C. under nitrogen gas airflow. Further, a mixture liquid of 55 g of 2-ethylhexyl acrylate and 55 g of methyl ethyl ketone and another mixture liquid of 1.0 g of 2,2′-azobis(2-methylbutyronitrile) and 25 g of methyl ethyl ketone are added thereto in 8 times at an interval of 15 minutes. The mixture is further heated and agitated for 3 hours at 80° C. Thus, a transparent solution of a silicon-containing polymer (1), having a weight average molecular weight of 105,000, is prepared.

### Synthesis Example 2

### (Synthesis of Silicon-Containing Polymer (2))

In a 5 L four-neck separable flask equipped with a stirrer and a condenser tube, 115 g of methyl ethyl ketone and 40 g of a silicon-containing radical-polymerizable monomer (SILAPLANE FM-7725 from Chisso Corporation) are contained and heated to 80° C. under nitrogen gas airflow. Further, a mixture liquid of 60 g of n-butyl acrylate and 60 g of methyl ethyl ketone and another mixture liquid of 1.0 g of 2,2′-azobis(2-methylbutyronitrile) and 25 g of methyl ethyl ketone are added thereto in 8 times at an interval of 15 minutes. The mixture is further heated and agitated for 3 hours at 80° C. Thus, a transparent solution of a silicon-containing polymer (2), having a weight average molecular weight of 124,000, is prepared.

### Synthesis Example 3

### (Synthesis of Silicon-Containing Polymer (3))

In a 5 L four-neck separable flask equipped with a stirrer and a condenser tube, 200 parts of toluene is contained and heated to 80° C. under nitrogen gas atmosphere. A mixture of 40 parts of n-butyl acrylate, 60 parts of γ-acryloxypropyltrimethoxysilane, and 2 parts of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a transparent solution of a silicon-containing polymer (3), having a weight average molecular weight of 45,000, is prepared.

### Synthesis Example 4

### (Synthesis of Silicon-Containing Polymer (4))

In a 5 L four-neck separable flask equipped with a stirrer and a condenser tube, 200 parts of toluene is contained and heated to 80° C. under nitrogen gas atmosphere. A mixture of 40 parts of n-butyl acrylate, 60 parts of a silicon-containing radical-polymerizable monomer (X-22-2475 from Shin-Etsu Chemical Co., Ltd.), and 2 parts of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a transparent solution of a silicon-containing polymer (4), having a weight average molecular weight of 54,000, is prepared.

### Synthesis Example 5

### (Synthesis of Silicon-Containing Polymer (5))

In a 5 L four-neck separable flask equipped with a stirrer and a condenser tube, 120 g of methyl ethyl ketone and 10 g of a silicon-containing radical-polymerizable monomer (X-22-2426 from Shin-Etsu Chemical Co., Ltd.) are contained and heated to 80° C. under nitrogen gas airflow. Further, a mixture liquid of 90 g of n-butyl acrylate and 40 g of methyl ethyl ketone and another mixture liquid of 1 g of 2,2′-azobis(2-methylbutyronitrile) and 20 g of methyl ethyl ketone are added thereto in 8 times at an interval of 15 minutes. The mixture is further heated and agitated for 3 hours at 80° C. Thus, a transparent solution of a silicon-containing polymer (5), having a weight average molecular weight of 148,000, is prepared.

### Synthesis Example 6

### (Synthesis of Silicon-Containing Polymer (6))

In a 5 L four-neck separable flask equipped with a stirrer and a condenser tube, 200 parts of toluene is contained and heated to 80° C. under nitrogen gas atmosphere. A mixture of 40 parts of n-butyl acrylate, 60 parts of a silicon-containing radical-polymerizable monomer (X-22-164 from Shin-Etsu Chemical Co., Ltd.), and 1.5 parts of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a transparent solution of a silicon-containing polymer (6), having a weight average molecular weight of 4,800, is prepared.

### Synthesis Example 7

### (Synthesis of Silicon-Containing Polymer (7))

In a 5 L four-neck separable flask equipped with a stirrer and a condenser tube, 200 parts of toluene is contained and heated to 80° C. under nitrogen gas atmosphere. A mixture of 90 parts of n-butyl acrylate, 10 parts of a silicon-containing radical-polymerizable monomer (X-22-164E from Shin-Etsu Chemical Co., Ltd.), and 1 part of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a transparent solution of a silicon-containing polymer (7), having a weight average molecular weight of 136,100, is prepared.

### Synthesis Example 8

### (Synthesis of Silicon-Containing Polymer (8))

In a 5 L four-neck separable flask equipped with a stirrer and a condenser tube, 200 parts of toluene is contained and heated to 80° C. under nitrogen gas atmosphere. A mixture of 60 parts of ethyl acrylate, 20 parts of methyl methacrylate, 20 parts of γ-acryloxypropylmethyldimethoxysilane, and 1.5 parts of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a transparent solution of a silicon-containing polymer (8), having a weight average molecular weight of 42,000, is prepared.

### Synthesis Example 9

### (Synthesis of Silicon-Containing Polymer (9))

In a 5 L four-neck separable flask equipped with a stirrer and a condenser tube, 140 g of methyl ethyl ketone and 65 g of a silicon-containing radical-polymerizable monomer (SILAPLANE FM-0721 from Chisso Corporation) are contained and heated to 80° C. under nitrogen gas airflow. Further, a mixture liquid of 35 g of 2-ethylhexyl acrylate and 35 g of methyl ethyl ketone and another mixture liquid of 1.0 g of 2,2′-azobis(2-methylbutyronitrile) and 25 g of methyl ethyl ketone are added thereto in 8 times at an interval of 15 minutes. The mixture is further heated and agitated for 3 hours at 80° C. Thus, a slightly whitish solution of a silicon-containing polymer (9), having a weight average molecular weight of 98,000, is prepared.

### Synthesis Example 10

### (Synthesis of Silicon-Containing Polymer (10))

In a 5 L four-neck separable flask equipped with a stirrer and a condenser tube, 140 g of methyl ethyl ketone and 65 g of a silicon-containing radical-polymerizable monomer (SILAPLANE FM-7711 from Chisso Corporation) are contained and heated to 80° C. under nitrogen gas airflow. Further, a mixture liquid of 35 g of octyl acrylate and 35 g of methyl ethyl ketone and another mixture liquid of 1.0 g of 2,2′-azobis(2-methylbutyronitrile) and 25 g of methyl ethyl ketone are added thereto in 8 times at an interval of 15 minutes. The mixture is further heated and agitated for 3 hours at 80° C. Thus, a slightly whitish solution of a silicon-containing polymer (10), having a weight average molecular weight of 102,000, is prepared.

### Synthesis Example 11

### (Synthesis of Silicon-Containing Polymer (11))

In a 5 L four-neck separable flask equipped with a stirrer and a condenser tube, 200 parts of toluene is contained and heated to 80° C. under nitrogen gas atmosphere. A mixture of 15 parts of n-octyl acrylate, 85 parts of γ-acryloxypropyltrimethoxysilane, and 2 parts of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a slightly whitish solution of a silicon-containing polymer (11), having a weight average molecular weight of 37,000, is prepared.

### Synthesis Example 12

### (Synthesis of Silicon-Containing Polymer (12))

In a 5 L four-neck separable flask equipped with a stirrer and a condenser tube, 120 g of methyl ethyl ketone and 3 g of a silicon-containing radical-polymerizable monomer (SILAPLANE FM-0725 from Chisso Corporation) are contained and heated to 80° C. under nitrogen gas airflow. Further, a mixture liquid of 97 g of butyl acrylate and 55 g of methyl ethyl ketone and another mixture liquid of 1.0 g of 2,2′-azobis(2-methylbutyronitrile) and 25 g of methyl ethyl ketone are added thereto in 8 times at an interval of 15 minutes. The mixture is further heated and agitated for 3 hours at 80° C. Thus, a transparent solution of a silicon-containing polymer (12), having a weight average molecular weight of 112,000, is prepared.

### Synthesis Example 13

### (Synthesis of Silicon-Containing Polymer (13))

In a 5 L four-neck separable flask equipped with a stirrer and a condenser tube, 115 g of methyl ethyl ketone and 3 g of a silicon-containing radical-polymerizable monomer (SILAPLANE FM-7721 from Chisso Corporation) are contained and heated to 80° C. under nitrogen gas airflow. Further, a mixture liquid of 97 g of n-butyl acrylate and 60 g of methyl ethyl ketone and another mixture liquid of 1.0 g of 2,2′-azobis(2-methylbutyronitrile) and 25 g of methyl ethyl ketone are added thereto in 8 times at an interval of 15 minutes. The mixture is further heated and agitated for 3 hours at 80° C. Thus, a transparent solution of a silicon-containing polymer (13), having a weight average molecular weight of 118,000, is prepared.

### Synthesis Example 14

### (Synthesis of Silicon-Containing Polymer (14))

In a 5 L four-neck separable flask equipped with a stirrer and a condenser tube, 200 parts of toluene is contained and heated to 80° C. under nitrogen gas atmosphere. A mixture of 92 parts of n-butyl acrylate, 8 parts of γ-acryloxypropyltrimethoxysilane, and 2 parts of 2,2′-azobisisobutyronitrile (AIBN from Wako Pure Chemical Industries, Ltd.) is dropped therein over a period of 2 hours while keeping the temperature at 80 to 90° C. The mixture is further heated for 8 hours at 80° C. Thus, a transparent solution of a silicon-containing polymer (14), having a weight average molecular weight of 52,000, is prepared.

### Synthesis Example 15

### (Synthesis of Polyester Resin (1))

In a reaction vessel equipped with a thermometer, a stirrer, a condenser tube, and a nitrogen inlet pipe, 64 parts of a PO adduct of bisphenol A (having a hydroxyl value of 320), 544 parts of an EO adduct of bisphenol A (having a hydroxyl value of 343), 123 parts of terephthalic acid, and 4 parts of dibutyltin oxide are contained, and reacted for 3 hours at 230° C. at normal pressures. After cooling the mixture to 180° C., 296 parts of dodecenyl succinic anhydride are added thereto, and reacted at a reduced pressure of from 10 to 15 mmHg until the acid value becomes 2 mgKOH/g or less. Further, 20 parts of trimellitic anhydride are added thereto, and reacted for 2 hours at 180° C. at normal pressures. The product is taken out of the reaction vessel. Thus, a polyester resin (1) is prepared. The polyester resin (1) has a glass transition temperature (Tg) of 48° C., a number average molecular weight of 9,000, a weight average molecular weight of 22,000, an acid value of 10 mgKOH/g, and a hydroxyl value of 17 mgKOH/g.

### Synthesis Example 16

### (Synthesis of Polyester Resin (2))

In a reaction vessel equipped with a thermometer, a stirrer, a condenser tube, and a nitrogen inlet pipe, 636 parts of a PO adduct of bisphenol A (having a hydroxyl value of 320), 191 parts of terephthalic acid, and 4 parts of dibutyltin oxide are contained, and reacted for 3 hours at 230° C. at normal pressures. After cooling the mixture to 180° C., 205 parts of dodecenyl succinic anhydride are added thereto, and reacted at a reduced pressure of from 10 to 15 mmHg until the acid value becomes 2 mgKOH/g or less. Further, 20 parts of trimellitic anhydride are added thereto, and reacted for 2 hours at 180° C. at normal pressures. The product is taken out of the reaction vessel. Thus, a polyester resin (2) is prepared. The polyester resin (2) has a glass transition temperature (Tg) of 55° C., a number average molecular weight of 5,000, a weight average molecular weight of 10,000, an acid value of 11 mgKOH/g, and a hydroxyl value of 16 mgKOH/g.

### Example 1

### (Preparation of Colorant Dispersion)

At first, 15 parts of a carbon black (REGAL® 400 from Cabot Corporation) and 3 parts of a colorant dispersing agent (AJISPER® PB-821 from Ajinomoto Fine-Techno Co., Inc.) are primarily dispersed in 82 parts of methyl ethyl ketone using a mixer equipped with agitation blades. Thus, a primary dispersion is prepared.

The primary dispersion is subjected to a dispersing treatment using a horizontal wet dispersing machine (DYNO-MILL from Shinmaru Enterprises Corporation) so that the colorant (i.e., carbon black) is very finely dispersed and aggregations thereof are completely removed by applying a strong shear force. Thus, a secondary dispersion is prepared.

The secondary dispersion is filtered with a filter (made of PTFE) having 0.45 μm-sized fine pores. Thus, a colorant dispersion (1) is prepared.

### (Preparation of Toner Constituent Liquid)

At first, 100 parts of the polyester resin (1), 30 parts of the colorant dispersion (1), 5 parts of a carnauba wax, 30 parts of the solution of the silicon-containing polymer (1), and 0.5 parts of FTERGENT F100 (from Neos Company Limited) are added to 1,000 parts of ethyl acetate, and dispersed for 10 minutes using a mixer equipped with agitation blades. The thus prepared dispersion is filtered with a filter (made of PTFE) having 0.45 μm-sized fine pores, without clogging the pores. The dispersion has an electrolytic conductivity of 3.4×10⁻⁷ S/m.

The dispersion is further diluted with ethyl acetate so that the resultant dispersion includes solid components in an amount of 6.0%. Thus, a toner constituent liquid (1) is prepared.

### (Preparation of Toner)

The toner constituent liquid (1) is supplied to the toner constituent liquid container 16 of the toner manufacturing apparatus 100 illustrated in FIG. 1. As the nozzle plate, a nickel plate having a thickness of 20 μm on which 10 circular discharge openings having an opening diameter of 8.0 μm are concentrically arranged is used. The discharge openings are formed by a laser ablation method in which a mask is reduced-projected by a femtosecond laser. The discharge openings are formed in a region having a substantially square shape, with each side having a length of 0.5 mm.

Liquid droplets of the toner constituent liquid are formed under the following conditions.

Solid component concentration of liquid: 6.0%

Flow rate of liquid: 40 ml/hr

Flow late of dried air: 2.0 L/min (sheath air), 3.0 L/min (inner air)

Inner temperature: 27 to 28° C.

Dew-point temperature: −20° C.

Vibration frequency: 601.0 kHz

The thus prepared liquid droplets are dried so as to form solid mother toner particles. The mother toner particles are collected using a cyclone collector.

Next, 100 parts of the mother toner particles are mixed with 0.2 parts of a hydrophobized silica (R-972 from Nippon Aerosil Co., Ltd.) using a HENSCHEL MIXER. Thus, a toner (1) is prepared.

### Examples 2 to 8

The procedure for preparing the toner (1) in Example 1 is repeated except for replacing the solution of the silicon-containing polymer (1) with that of the silicon-containing polymers (2) to (8), respectively. Thus, toners (2) to (8) are prepared.

### Example 9

### (Preparation of Colorant Dispersion)

At first, 15 parts of a carbon black (REGAL® 400 from Cabot Corporation) and 3 parts of a colorant dispersing agent (AJISPER® PB-821 from Ajinomoto Fine-Techno Co., Inc.) are primarily dispersed in 82 parts of ethyl acetate using a mixer equipped with agitation blades. Thus, a primary dispersion is prepared.

The primary dispersion is subjected to a dispersing treatment using a horizontal wet dispersing machine (DYNO-MILL from Shinmaru Enterprises Corporation) so that the colorant (i.e., carbon black) is much finely dispersed and aggregations thereof are completely removed by applying a strong shear force. Thus, a secondary dispersion is prepared.

The secondary dispersion is filtered with a filter (made of PTFE) having 0.45 μm-sized fine pores. Thus, a colorant dispersion (2) is prepared.

### (Preparation of Toner Constituent Liquid)

At first, 100 parts of the polyester resin (2), 30 parts of the colorant dispersion (2), 5 parts of a carnauba wax, 30 parts of the solution of the silicon-containing polymer (1), and 0.5 parts of FTERGENT F100 (from Neos Company Limited) are added to 1,000 parts of ethyl acetate, and dispersed for 10 minutes using a mixer equipped with agitation blades. The thus prepared dispersion is filtered with a filter (made of PTFE) having 0.45 μm-sized fine pores, without clogging the pores. The dispersion has an electrolytic conductivity of 3.4×10⁻⁷ S/m.

The dispersion is further diluted with ethyl acetate so that the resultant dispersion includes solid components in an amount of 6.0%. Thus, a toner constituent liquid (2) is prepared.

### (Preparation of Toner)

The toner constituent liquid (2) is supplied to the toner constituent liquid container 35 of the toner manufacturing apparatus 200 illustrated in FIG. 3. As the nozzle plate 21, a nickel plate having a thickness of 20 μm on which 10 circular discharge openings having an opening diameter of 8.0 μm are concentrically arranged is used. The discharge openings are formed by a laser ablation method in which a mask is reduced-projected by a femtosecond laser. The discharge openings are formed in a region having a substantially square shape, with each side having a length of 0.5 mm.

Liquid droplets of the toner constituent liquid (2) are formed under the following conditions.

Solid component concentration of liquid: 6.0%

Flow rate of liquid: 40 ml/hr

Flow late of dried air: 2.0 L/min (sheath air), 3.0 L/min (inner air)

Inner temperature: 27 to 28° C.

Dew-point temperature: −20° C.

Vibration frequency: 601.0 kHz

The thus prepared liquid droplets are dried so as to form solid mother toner particles. The mother toner particles are collected using a cyclone collector.

Next, 100 parts of the mother toner particles are mixed with 0.2 parts of a hydrophobized silica (R-972 from Nippon Aerosil Co., Ltd.) using a HENSCHEL MIXER. Thus, a toner (9) is prepared.

### Examples 10 to 15

The procedure for preparing the toner (1) in Example 1 is repeated except for replacing the solution of the silicon-containing polymer (1) with that of the silicon-containing polymers (9) to (14), respectively. Thus, toners (10) to (15) are prepared.

### Examples 16 to 19

The procedure for preparing the toner (1) in Example 1 is repeated except that the amount of the solution of the silicon-containing polymer (1) is changed from 30 parts to 2, 6, 50, and 80 parts, respectively. Thus, toners (16) to (19) are prepared.

### Example 20

The procedure for preparing the toner (9) in Example 9 is repeated except for replacing 30 parts of the solution of the silicon-containing polymer (1) with 10 parts of a silicone oil (KF96;1000CP from Shin-Etsu Chemical Co., Ltd.). Thus, a toner (20) is prepared.

### Example 21

The procedure for preparing the toner (9) in Example 9 is repeated except for replacing 30 parts of the solution of the silicon-containing polymer (1) with 10 parts of a silicone resin (840 RESIN from Dow Coming Toray Co., Ltd.). Thus, a toner (21) is prepared.

### Comparative Example 1

The procedure for preparing the toner (9) in Example 9 is repeated except that the solution of the silicon-containing polymer (1) is not added. Thus, a toner (22) is prepared.

### Comparative Example 2

The procedure for preparing the toner (22) in Comparative Example 1 is repeated except that 0.2 parts of the hydrophobized silica (R-972 from Nippon Aerosil Co., Ltd.) is replaced with 0.7 parts of a hydrophobized silica (HDK2000H from Wacker-Chemie GmbH) and 0.8 parts of a hydrophobized titanium oxide (STT-30A from Titan Kogyo Co., Ltd.). Thus, a toner (23) is prepared.

### Comparative Example 3

At first, 100 parts of the polyester resin (1), 4.5 parts of a carbon black (REGAL® 400 from Cabot Corporation), 5 parts of a carnauba wax, and 0.5 parts of FTERGENT F100 (from Neos Company Limited) are mixed using a HENSCHEL MIXER. The mixture is kneaded using a BUSS KO-KNEADER PCS30. The kneaded mixture is cooled in the air, and subsequently coarsely pulverized using an ALPINE ROTOPLEX (from Hosokawa Micron Corporation) and finely pulverized using a MICRON JET MJT-1 (from Hosokawa Micron Corporation). The pulverized particles are classified. Thus, mother toner particles are prepared.

Next, 100 parts of the mother toner particles are mixed with 0.2 parts of a hydrophobized silica (R-972 from Nippon Aerosil Co., Ltd.) using a HENSCHEL MIXER. Thus, a toner (24) is prepared.

### Comparative Example 4

The procedure for preparing the toner (24) in Comparative Example 3 is repeated except that 0.2 parts of the hydrophobized silica (R-972 from Nippon Aerosil Co., Ltd.) is replaced with 0.7 parts of a hydrophobized silica (HDK2000H from Wacker-Chemie GmbH) and 0.8 parts of a hydrophobized titanium oxide (STT-30A from Titan Kogyo Co., Ltd.). Thus, a toner (25) is prepared.

### Measurement of Particle Diameter

The particle diameter distribution of each of the above-prepared toners is measured using COULTER COUNTER TA-II. The weight average particle diameter (D4) and the number average particle diameter (Dn) are determined from the particle diameter distribution.

The particle diameter distribution is evaluated based on the ratio (D4/Dn) of the weight average particle diameter (D4) to the number average particle diameter (Dn), and graded as follows:

Good: D4/Dn is less than 1.05

Average: D4/Dn is not less than 1.05 and less than 1.10

Poor: D4/Dn is not less than 1.10

The measurement results are shown in Table 1.

TABLE 1

| | | | | Particle |
|---|---|---|---|---|
| | | Weight Average | Number Average | Diameter |
| | | Particle Diameter | Particle Diameter | Distribution |
| | Toner | (D4 (μm)) | (Dn (μm)) | (D4/Dn) |
| Example 1 | 1 | 5.8 | 5.7 | 1.02 |
| Example 2 | 2 | 5.7 | 5.7 | 1.00 |
| Example 3 | 3 | 5.7 | 5.7 | 1.00 |
| Example 4 | 4 | 5.7 | 5.7 | 1.00 |
| Example 5 | 5 | 5.7 | 5.7 | 1.00 |
| Example 6 | 6 | 5.7 | 5.7 | 1.00 |
| Example 7 | 7 | 5.8 | 5.7 | 1.02 |
| Example 8 | 8 | 5.7 | 5.7 | 1.00 |
| Example 9 | 9 | 5.7 | 5.7 | 1.00 |
| Example 10 | 10 | 5.7 | 5.7 | 1.00 |
| Example 11 | 11 | 5.7 | 5.7 | 1.00 |
| Example 12 | 12 | 5.7 | 5.7 | 1.00 |
| Example 13 | 13 | 5.7 | 5.7 | 1.00 |
| Example 14 | 14 | 5.7 | 5.7 | 1.00 |
| Example 15 | 15 | 5.8 | 5.7 | 1.02 |
| Example 16 | 16 | 5.7 | 5.7 | 1.00 |
| Example 17 | 17 | 5.7 | 5.7 | 1.00 |
| Example 18 | 18 | 5.8 | 5.7 | 1.02 |
| Example 19 | 19 | 5.7 | 5.7 | 1.00 |
| Example 20 | 20 | 5.7 | 5.7 | 1.00 |
| Example 21 | 21 | 5.7 | 5.7 | 1.00 |
| Comparative | 22 | 5.8 | 5.7 | 1.02 |
| Example 1 | | | | |
| Comparative | 23 | 5.7 | 5.7 | 1.00 |
| Example 2 | | | | |
| Comparative | 24 | 7.8 | 6.1 | 1.28 |
| Example 3 | | | | |
| Comparative | 25 | 7.8 | 6.1 | 1.28 |
| Example 4 | | | | |

### Preparation of Developer

A silicone resin (SR2411 from Dow Coming Toray Co., Ltd.) is diluted so that a silicone resin solution including solid components in an amount of 5% by weight is prepared. An aminosilane coupling agent H₂N(CH₂)Si(OC₂H₅)₃,in an amount of 3% by weight based on the solid components, is further added to the silicone resin solution. The silicone resin solution is coated on the surfaces of copper-zinc ferrite particles (F-300 from Powdertech Co., Ltd.) using a fluidized bed coating device at a temperature of 100° C. and a coating rate of about 40 g/min. The coated ferrite particles are further heated for 2 hours at 240° C. Thus, a carrier having a silicone resin layer having a thickness of 0.38 μm is prepared.

Next, 5 parts of each toner and 95 parts of the carrier are mixed to prepare a developer. The developer is subjected to the following evaluations of the toner.

### Evaluations

Each of the above-prepared developer is set in a tandem color printer (IPSIO CX9000 from Ricoh Co., Ltd.), and an image having an image proportion of 5% is formed on a coping paper (TYPE6000 from Ricoh Co., Ltd.) so that 1.00±0.05 mg/cm² of the toner is adhered thereto. A running test in which the image is repeatedly formed on 10,000 sheets of the copying paper at 20° C. and 60% RH is performed, and image density, image quality, fixing quality, and charge quantity, to be described later, are evaluated thereafter. In a similar way, running tests in which the image is repeatedly formed on 5,000 sheets of the copying paper at 10° C. and 30% RH, and 30° C. and 90% RH, respectively, are performed, and the image density, image quality, fixing quality, and charge quantity are evaluated thereafter.

### (1) Image Density

The image density of the produced image is measured using SPECTRODENSITOMETER X-RITE 938 (from X-Rite, Incorporated) at settings of D65 illuminant, 2 degrees observer, and status T, and evaluated as follows:

Good: not less than 1.4

Average: not less than 1.2 and less than 1.4

Poor: less than 1.2

### (2) Image Quality

To evaluate the image quality, the produced image is visually observed whether or not background fouling, blurred image, and faint image occur. The image quality is graded as follows:

Good: None of background fouling, blurred image, and faint image is observed.

Average: Any one of background fouling, blurred image, and faint image is slightly observed.

Poor: Any one of background fouling, blurred image, and faint image is observed.

### (3) Fixing Quality

To evaluate the fixing quality, a solid image having an area of 50 mm×30 mm is continuously formed on 10 sheets of a copying paper (TYPE6000 from Ricoh Co., Ltd.) so that 1.00±0.05 mg/cm² of the toner is adhered to each of the sheets. The image on the 9^{th} and 10^{th} sheets are scratched with a drawing needle, and visually observed whether or not the toner is peeled off and the paper is exposed. The fixing quality is graded as follows:

Good: The toner is not peeled off.

Average: The toner is partially peeled off, but the paper is not exposed.

Poor: The toner is peeled off, and the paper is exposed.

### (4) Charge Quantity

At a time the image density and image quality are evaluated as described above, the developer is sampled out of the tandem color printer. To measure the charge quantity, 0.5 of the developer is contained in a Faraday gauge so that the toner in the developer is blown off.

### (5) Toner Feed Ability

The toner feed ability is evaluated as follows:

Good: No problem occurs while the running tests, producing total 20,000 sheets of the image, are performed.

Poor: A toner end detection lamp lights up and the printer stop operating, even if the toner is contained in a toner container.

The results of the above-described evaluations are shown in Tables 2 to 6.

TABLE 2

| | Image Density | | | |
|---|---|---|---|---|
| | | | | After |
| | | | | Producing |
| | | | | 5,000 |
| | | After Producing | After Producing | sheets at |
| | Initial | 10,000 sheets at | 5,000 sheets at | 30° and |
| | Stage | 20° and 60% RH | 10° and 30% RH | 90% RH |
| Example 1 | Good | Good | Good | Good |
| Example 2 | Good | Good | Good | Good |
| Example 3 | Good | Good | Good | Good |
| Example 4 | Good | Good | Good | Good |
| Example 5 | Good | Good | Good | Good |
| Example 6 | Good | Good | Good | Good |
| Example 7 | Good | Good | Good | Good |
| Example 8 | Good | Good | Good | Good |
| Example 9 | Good | Good | Good | Good |
| Example 10 | Good | Good | Good | Good |
| Example 11 | Good | Good | Good | Good |
| Example 12 | Good | Good | Good | Good |
| Example 13 | Good | Good | Good | Good |
| Example 14 | Good | Good | Good | Good |
| Example 15 | Good | Good | Good | Good |
| Example 16 | Good | Good | Good | Good |
| Example 17 | Good | Good | Good | Good |
| Example 18 | Good | Good | Good | Good |
| Example 19 | Good | Average | Average | Good |
| Example 20 | Good | Good | Good | Good |
| Example 21 | Good | Good | Good | Good |
| Comparative | Good | Good | Good | — |
| Example 1 | | | | |
| Comparative | Good | Good | Good | Poor |
| Example 2 | | | | |
| Comparative | Good | — | — | — |
| Example 3 | | | | |
| Comparative | Good | Good | Good | Poor |
| Example 4 | | | | |

TABLE 3

| | Image Quality | | | |
|---|---|---|---|---|
| | | | | After |
| | | | | Producing |
| | | | | 5,000 |
| | | After Producing | After Producing | sheets at |
| | Initial | 10,000 sheets at | 5,000 sheets at | 30° and |
| | Stage | 20° and 60% RH | 10° and 30% RH | 90% RH |
| Example 1 | Good | Good | Good | Good |
| Example 2 | Good | Good | Good | Good |
| Example 3 | Good | Good | Good | Good |
| Example 4 | Good | Good | Good | Good |
| Example 5 | Good | Good | Good | Good |
| Example 6 | Good | Good | Good | Good |
| Example 7 | Good | Good | Good | Good |
| Example 8 | Good | Good | Good | Good |
| Example 9 | Good | Good | Good | Good |
| Example 10 | Good | Good | Good | Good |
| Example 11 | Good | Good | Good | Good |
| Example 12 | Good | Good | Good | Good |
| Example 13 | Good | Good | Good | Good |
| Example 14 | Good | Good | Good | Good |
| Example 15 | Good | Good | Good | Good |
| Example 16 | Good | Good | Good | Average |
| Example 17 | Good | Good | Good | Good |
| Example 18 | Good | Good | Good | Good |
| Example 19 | Good | Average | Good | Good |
| Example 20 | Good | Good | Good | Good |
| Example 21 | Good | Good | Good | Good |
| Comparative | Average | Poor | Good | — |
| Example 1 | | | | |
| Comparative | Good | Poor | Poor | Poor |
| Example 2 | | | | |
| Comparative | Average | — | — | — |
| Example 3 | | | | |
| Comparative | Good | Poor | Poor | Poor |
| Example 4 | | | | |

TABLE 4

| | Fixing Quality | | | |
|---|---|---|---|---|
| | | | | After |
| | | | | Producing |
| | | | | 5,000 |
| | | After Producing | After Producing | sheets at |
| | Initial | 10,000 sheets at | 5,000 sheets at | 30° and |
| | Stage | 20° and 60% RH | 10° and 30% RH | 90% RH |
| Example 1 | Good | Good | Good | Good |
| Example 2 | Good | Good | Good | Good |
| Example 3 | Good | Good | Good | Good |
| Example 4 | Good | Good | Good | Good |
| Example 5 | Good | Good | Good | Good |
| Example 6 | Good | Good | Good | Good |
| Example 7 | Good | Good | Good | Good |
| Example 8 | Good | Good | Good | Good |
| Example 9 | Good | Good | Good | Good |
| Example 10 | Good | Good | Good | Good |
| Example 11 | Good | Good | Good | Good |
| Example 12 | Good | Good | Good | Good |
| Example 13 | Good | Good | Good | Good |
| Example 14 | Good | Good | Good | Good |
| Example 15 | Good | Good | Good | Good |
| Example 16 | Good | Good | Good | Good |
| Example 17 | Good | Good | Good | Good |
| Example 18 | Good | Good | Good | Good |
| Example 19 | Good | Average | Average | Good |
| Example 20 | Good | Good | Good | Good |
| Example 21 | Good | Good | Good | Good |
| Comparative | Good | Good | Good | — |
| Example 1 | | | | |
| Comparative | Good | Good | Good | Good |
| Example 2 | | | | |
| Comparative | Good | — | — | — |
| Example 3 | | | | |
| Comparative | Good | Good | Good | Good |
| Example 4 | | | | |

TABLE 5

| | Charge Quantity (−μC/g) | | | |
|---|---|---|---|---|
| | | | | After |
| | | | | Producing |
| | | | | 5,000 |
| | | After Producing | After Producing | sheets at |
| | Initial | 10,000 sheets at | 5,000 sheets at | 30° and |
| | Stage | 20° and 60% RH | 10° and 30% RH | 90% RH |
| Example 1 | 21 | 21 | 20 | 19 |
| Example 2 | 20 | 19 | 19 | 19 |
| Example 3 | 22 | 21 | 22 | 21 |
| Example 4 | 24 | 22 | 23 | 22 |
| Example 5 | 18 | 18 | 19 | 18 |
| Example 6 | 24 | 23 | 23 | 24 |
| Example 7 | 17 | 17 | 18 | 17 |
| Example 8 | 18 | 19 | 19 | 18 |
| Example 9 | 21 | 20 | 20 | 20 |
| Example 10 | 23 | 22 | 21 | 21 |
| Example 11 | 23 | 21 | 20 | 20 |
| Example 12 | 25 | 24 | 24 | 23 |
| Example 13 | 17 | 18 | 18 | 19 |
| Example 14 | 17 | 17 | 17 | 17 |
| Example 15 | 17 | 17 | 18 | 18 |
| Example 16 | 16 | 16 | 16 | 15 |
| Example 17 | 18 | 17 | 17 | 17 |
| Example 18 | 24 | 23 | 23 | 22 |
| Example 19 | 26 | 26 | 27 | 26 |
| Example 20 | 19 | 18 | 18 | 18 |
| Example 21 | 20 | 18 | 19 | 18 |
| Comparative | 16 | 16 | 16 | — |
| Example 1 | | | | |
| Comparative | 21 | 17 | 14 | 9 |
| Example 2 | | | | |
| Comparative | 16 | — | — | — |
| Example 3 | | | | |
| Comparative | 21 | 16 | 13 | 10 |
| Example 4 | | | | |

TABLE 6

| | Toner | Toner Feed Ability |
|---|---|---|
| Example 1 | 1 | Good |
| Example 2 | 2 | Good |
| Example 3 | 3 | Good |
| Example 4 | 4 | Good |
| Example 5 | 5 | Good |
| Example 6 | 6 | Good |
| Example 7 | 7 | Good |
| Example 8 | 8 | Good |
| Example 9 | 9 | Good |
| Example 10 | 10 | Good |
| Example 11 | 11 | Good |
| Example 12 | 12 | Good |
| Example 13 | 13 | Good |
| Example 14 | 14 | Good |
| Example 15 | 15 | Good |
| Example 16 | 16 | Good |
| Example 17 | 17 | Good |
| Example 18 | 18 | Good |
| Example 19 | 19 | Good |
| Example 20 | 20 | Good |
| Example 21 | 21 | Good |
| Comparative Example 1 | 22 | Poor |
| Comparative Example 2 | 23 | Good |
| Comparative Example 3 | 24 | Good |
| Comparative Example 4 | 25 | Poor |

It is clear from the above results that the toner has stable charge quantity and high quality images are produced in Examples 1 to 21 each. In Comparative Examples 1 and 3, the toner feed ability is poor. In Comparative Examples 2 and 4, the charge quantity of the toner largely decreases and the image quality is poor. In Comparative Example 1 and 2, a toner end detect lamp lights up when 10,320^{th} and 420^{th} sheet, respectively, is produced, and the printer stops operating. In Comparative Examples 1 and 3, abnormal images with white spots (i.e., voids) are produced. In Comparative Examples 2 and 4, abnormal images with thickened image are produced and transfer defect occurred in solid portion.

This document claims priority and contains subject matter related to Japanese Patent Applications Nos. 2007-066176 and 2007-323042, filed on Mar. 15, 2007 and Dec. 14, 2007, respectively, the entire contents of each of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner, comprising:
a binder resin;
a colorant; and
a silicon-containing polymer,
wherein the toner is manufactured by a method comprising:
discharging a toner constituent liquid comprising toner constituents comprising the binder resin, the colorant, and the silicon-containing polymer, from at least one discharge opening to form liquid droplets thereof; and
converting the liquid droplets into solid toner particles in a granulation space.

2. The toner according to claim 1, wherein the toner constituent liquid further comprises an organic solvent in which the binder resin, the colorant, and the silicon-containing polymer are dissolved or dispersed.

3. The toner according to claim 2, wherein the silicon-containing polymer is soluble in the organic solvent.

4. The toner according to claim 1, wherein the silicon-containing polymer is in a solid state at room temperature.

5. The toner according to claim 1, wherein the silicon-containing polymer comprises a straight-chain silicone resin.

6. The toner according to claim 1, wherein the silicon-containing polymer comprises a unit of a silicon-containing radical-polymerizable monomer.

7. The toner according to claim 6, wherein the silicon-containing radical-polymerizable monomer has the following formula (1): 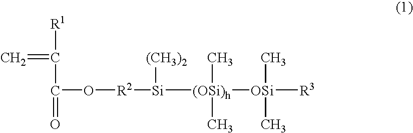
wherein R¹ represents a hydrogen atom or a methyl group; R² represents a divalent hydrocarbon group having 1 to 6 carbon atoms, which may have an oxygen atom in a main chain thereof; R³ represents an alkyl group having 1 to 30 carbon atoms, an aromatic group, or a hydroxyl group; and h represents an integer of from 1 to 200.

8. The toner according to claim 7, wherein the silicon-containing polymer comprises a copolymer comprising a unit of the silicon-containing radical-polymerizable monomer having the formula (1) in an amount of from 5-60% by weight.

9. The toner according to claim 6, wherein the silicon-containing radical-polymerizable monomer has the following formula (2): 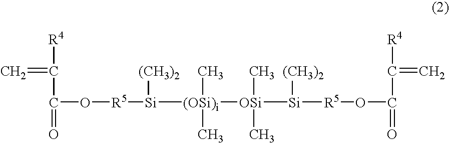
wherein R⁴ represents a hydrogen atom or a methyl group; R⁵ represents a divalent hydrocarbon group having 1 to 6 carbon atoms, which may have an oxygen atom in a main chain thereof; and i represents an integer of from 0 to 150.

10. The toner according to claim 9, wherein the silicon-containing polymer comprises a copolymer comprising a unit of the silicon-containing radical-polymerizable monomer having the formula (2) in an amount of from 5-60% by weight.

11. The toner according to claim 6, wherein the silicon-containing radical-polymerizable monomer has the following formula (3): 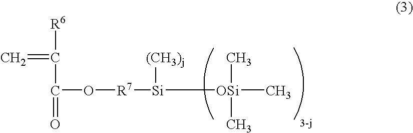
wherein R⁶ represents a hydrogen atom or a methyl group; R⁷ represents a divalent hydrocarbon group having 1 to 6 carbon atoms, which may have an oxygen atom in a main chain thereof; and j represents an integer of 0, 1, or 2.

12. The toner according to claim 11, wherein the silicon-containing polymer comprises a copolymer comprising a unit of silicon-containing radical-polymerizable monomer having the formula (3) in an amount of from 10-80% by weight.

13. The toner according to claim 1, wherein the toner constituent liquid comprises the silicon-containing polymer in an amount of from 1 to 20 parts by weight, based on 100 parts by weight of the toner constituents except for the silicon-containing polymer.

14. The toner according to claim 1, wherein the toner has a weight average particle diameter of from 1 to 6 μm and a ratio of the weight average particle diameter to a number average particle diameter of from 1.00 to 1.10.

15. The toner according to claim 1, wherein the at least one discharge opening comprises a plurality of discharge openings provided on a nozzle plate.

16. The toner according to claim 1, wherein the discharged toner constituent liquid is vibrated to form the liquid droplets.

17. The toner according to claim 15, wherein the nozzle plate is vibrated to vibrate the toner constituent liquid.

18. The toner according to claim 16, wherein the discharged toner constituent liquid is vibrated at a frequency of from 50 kHz to 50 MHz.

19. A developer, comprising the toner according to claim 1 and a carrier.

20. An image forming apparatus, comprising:
an electrostatic latent image bearing member;
an electrostatic latent image forming device configured to form an electrostatic latent image on the electrostatic latent image bearing member;
a developing device configured to develop the electrostatic latent image with the toner according to claim 1 to form a toner image;
a transfer device configured to transfer the toner image onto a recording medium; and
a fixing device configured to fix the toner image to the recording medium by application of heat and pressure from a fixing member with a roller or belt shape.
